(19) United States
(12) Patent Application Publication
(10) Pub. No.: US 2026/0344812 A1
(43) Pub. Date: Nov. 5, 2026

(54) SYSTEM AND METHOD FOR DISPLAYING IDENTIFICATION INFORMATION ON APPAREL

(71) Applicant: Ray Dancewear LLC, Nampa, ID (US)

(72) Inventors: Addison Reader, Meridian, ID (US); Rachael Gray, Nampa, ID (US)

(73) Assignee: Ray Dancewear LLC, Nampa, ID (US)

(21) Appl. No.: 19/665,916

(22) Filed: May 1, 2026

Related U.S. Application Data
(60) Provisional application No. 63/836,166, filed on Jun. 30, 2025.
(60) Provisional application No. 63/799,101, filed on May 2, 2025.

(51) Int. Cl. A41D 27/20; G09F 3/20

(52) U.S. Cl. CPC A41D 27/20; G09F 3/201; G09F 3/207; A41D 2600/10

(57) ABSTRACT

An identification display system includes a display pocket, an attachment interface, and an identification insert. The display pocket includes a front panel, a rear panel joined to the front panel along a bottom edge and along two side edges of the display pocket, and a pocket opening between the front panel and the rear panel along an upper edge of the display pocket. The pocket opening is sized to receive the identification insert. The front panel includes a viewing region dimensioned to render the identification insert visible through the front panel. The attachment interface is coupled to the rear panel and couples the display pocket to an apparel substrate through a stitched seam, an adhesive layer, a hook-and-loop component, a magnetic element, a snap component, a zipper, a thermally-bonded seam, or a combination thereof. A method for manufacturing the system is also disclosed.

### CROSS-REFERENCE TO RELATED APPLICATIONS

The present application claims priority under 35 U.S.C. § 119(e) to U.S. Provisional Application No. 63/799,101, filed May 2, 2025, and titled “APPARATUS FOR DISPLAYING IDENTIFICATION INFORMATION ON APPAREL,” and to U.S. Provisional Application No. 63/836,166, filed Jun. 30, 2025, and titled “APPARATUS AND SYSTEM FOR TEMPORARILY DISPLAYING IDENTIFICATION INFORMATION ON APPAREL.” Each of the foregoing applications is incorporated herein by reference in its entirety.

### FIELD OF THE ART

The systems and methods disclosed herein relate generally to wearable identification display apparatus and, more specifically, to display pockets operable to retain removable identification inserts on apparel substrates.

### BACKGROUND

Participants in performance-based activities, including dance competitions, athletic events, and similar evaluation-based settings, are commonly required to display identification information on their apparel. Identification information may include competition numbers, names, role designations, or other markers used for tracking, scoring, or participant assignment.

Conventional approaches to displaying identification information on apparel rely on temporary or semi-permanent attachments such as pressure-sensitive stickers and safety pins. Stickers are prone to detachment during physical activity, especially in the presence of perspiration or friction. Stickers are also single-use and tend to become unreadable due to creasing or wear. Safety pins provide a more secure connection but require piercing the garment, which damages fabric and compromises the fit of performance-oriented or custom-made clothing.

Alternative approaches, including adhesive tags, clip-on badges, and magnetic holders, have been introduced to avoid garment damage. Each of these approaches, however, tends to suffer from insufficient retention during active movement, discomfort during wear, limited compatibility with performance fabrics, and the introduction of residue, bulk, or localized stress points that interfere with the function or appearance of the underlying apparel.

Existing approaches also tend to lack reusability and adaptability. Many are configured for single-use application or a specific garment type, with limited capacity for transfer between outfits or retention during extended active movement. In environments where participants frequently change apparel, such as dance and team sports, the lack of cross-garment adaptability remains a challenge.

Accordingly, there remains a need for an identification display apparatus that retains identification information securely on apparel without damaging the garment, supports reusability across multiple garments and events, and maintains visibility during active movement.

### SUMMARY

Systems and methods in accordance with various embodiments of the present disclosure provide apparatus for displaying identification information on apparel. Various embodiments include a display pocket, an attachment interface, and an identification insert, cooperating to retain identification information in a visible orientation on an apparel substrate while preserving garment integrity and supporting reusability across multiple garments, events, and identification content.

In various embodiments, the display pocket includes a front panel, a rear panel joined to the front panel along a bottom edge of the display pocket and along two side edges of the display pocket, and a pocket opening between the front panel and the rear panel along an upper edge of the display pocket. The pocket opening is sized to receive an identification insert. The front panel includes a viewing region dimensioned to render the identification insert visible through the front panel after the identification insert is received between the front panel and the rear panel.

In various embodiments, an attachment interface is coupled to the rear panel of the display pocket. The attachment interface is arranged to couple the display pocket to an apparel substrate and may take a variety of forms, including a stitched seam, an adhesive layer, a hook-and-loop component, a magnetic element, a snap component, a thermally-bonded seam, or a combination thereof. Selected attachment interfaces support permanent integration of the display pocket during garment manufacture; other attachment interfaces support user-installable or removable application to an existing garment.

In various embodiments, the apparatus further includes retention features operable to retain the identification insert between the front panel and the rear panel. Such retention features include a flap foldable over the pocket opening, a bias urging the front panel and the rear panel toward each other along the pocket opening to form a pressure fit, and a textured friction surface on an interior face of the front panel, an interior face of the rear panel, or both, operable to engage the identification insert through friction. Retention features may be provided singly or in combination.

In various embodiments, the identification insert may include a perforated tear line separable to detach a portion of the identification insert from a remainder of the identification insert, such that a portion of the identification content can be removed without replacing the insert. In various embodiments, the identification insert may include a re-writable surface operable to support replaceable identification markings. In various embodiments, the display pocket may further include a flexible display medium operable to render alphanumeric identification data electronically, the flexible display medium electrically coupled to a controller.

In various embodiments, the apparatus is provided as a kit including the display pocket, the identification insert, and installation instructions describing a process for coupling the display pocket to an apparel substrate through the attachment interface. In other embodiments, the display pocket is integrated into the apparel substrate during garment manufacture, including by passing a thread through the rear panel and a garment surface along a perimeter of the rear panel to form a stitched seam, by applying an adhesive layer between the rear panel and the garment surface, or by forming a thermally-bonded seam between the rear panel and the garment surface through thermal fusion of a fusible material.

Various other functions and advantages are described and suggested below as may be provided in accordance with the various embodiments.

### BRIEF DESCRIPTION OF THE DRAWINGS

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1A illustrates an example identification display system, in accordance with various embodiments.

FIG. 1B illustrates an example three-quarter perspective view of a display pocket, in accordance with various embodiments.

FIG. 2 illustrates an example exploded configuration of an identification display system, in accordance with various embodiments.

FIG. 3A illustrates an example stitched-seam attachment interface coupling a display pocket to an apparel substrate, in accordance with various embodiments.

FIG. 3B illustrates an example adhesive-layer attachment interface coupling a display pocket to an apparel substrate, in accordance with various embodiments.

FIG. 3C illustrates an example hook-and-loop attachment interface coupling a display pocket to an apparel substrate, in accordance with various embodiments.

FIG. 3D illustrates an example magnetic attachment interface coupling a display pocket to an apparel substrate, in accordance with various embodiments.

FIG. 3E illustrates an example zipper-based attachment interface coupling a display pocket to an apparel substrate, in accordance with various embodiments.

FIG. 3F illustrates an example snap-based attachment interface coupling a display pocket to an apparel substrate, in accordance with various embodiments.

FIG. 3G illustrates an example thermally-bonded seam coupling a display pocket to an apparel substrate, in accordance with various embodiments.

FIG. 4A illustrates an example flap over a pocket opening of a display pocket in an open position, in accordance with various embodiments.

FIG. 4B illustrates an example flap over a pocket opening of a display pocket in a closed position, in accordance with various embodiments.

FIG. 5 illustrates an example pressure-fit configuration of a display pocket, in accordance with various embodiments.

FIG. 6 illustrates an example friction-fit configuration of a display pocket, in accordance with various embodiments.

FIG. 7 illustrates an example tear-away identification insert, in accordance with various embodiments.

FIG. 8 illustrates an example re-writable identification insert, in accordance with various embodiments.

FIG. 9 illustrates an example flexible display medium configuration of a display pocket, in accordance with various embodiments.

FIG. 10 illustrates an example kit including a display pocket, an identification insert, and installation instructions, in accordance with various embodiments.

FIG. 11 illustrates an example method for manufacturing an identification display system, in accordance with various embodiments.

FIG. 12 illustrates an example computing device operable to support electronic embodiments of an identification display system, in accordance with various embodiments.

FIG. 13 illustrates an example network environment operable to support electronic embodiments of an identification display system, in accordance with various embodiments.

FIG. 14 illustrates an example memory architecture operable to support electronic embodiments of an identification display system, in accordance with various embodiments.

FIG. 15 illustrates an example display driver architecture operable to support electronic embodiments of an identification display system, in accordance with various embodiments.

### DETAILED DESCRIPTION OF EMBODIMENTS

The embodiments described herein relate to systems and methods for displaying identification information on apparel. The systems and methods described herein retain an identification insert in a visible orientation on an apparel substrate through a display pocket coupled to the apparel substrate by an attachment interface, while preserving garment integrity, supporting reusability across multiple garments and events, and accommodating diverse garment constructions and fabric types.

In certain embodiments, the disclosed systems and methods may be applied in dance competitions, athletic events, team uniforms, performance costumes, staff identification, and other contexts in which identification information is displayed on apparel during active movement. The disclosed systems and methods may also be applied to educational programs, backstage crew coordination, event-based access control, and similar contexts in which identification information is temporarily associated with a wearer.

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices and parts that are connected to each other need not be in continuous connection with each other, unless expressly specified otherwise. In addition, devices and parts that are connected with each other may be connected directly or indirectly through one or more connection means or intermediaries.

A description of an aspect with several components in connection with each other does not imply that all such components are required. To the contrary, a variety of optional components may be described to illustrate a wide variety of possible embodiments and in order to more fully illustrate one or more embodiments. Similarly, although process steps, method steps, or the like may be described in a sequential order, such processes and methods may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, or method is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Alternate implementations are included within the scope of various embodiments in which, for example, functions may be executed out of order from that shown or discussed, including substantially concurrently or in reverse order, depending on the functionality involved, as would be understood by those having ordinary skill in the art.

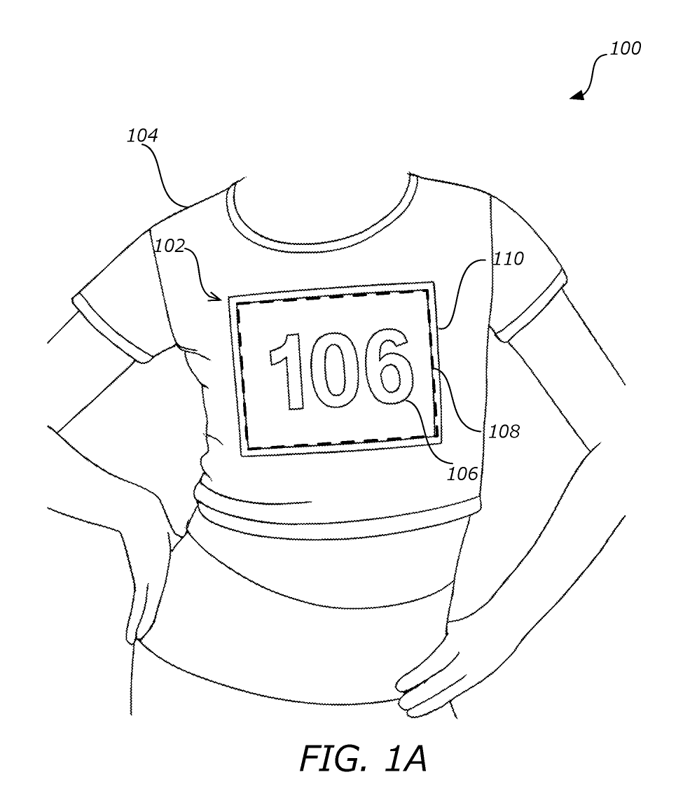

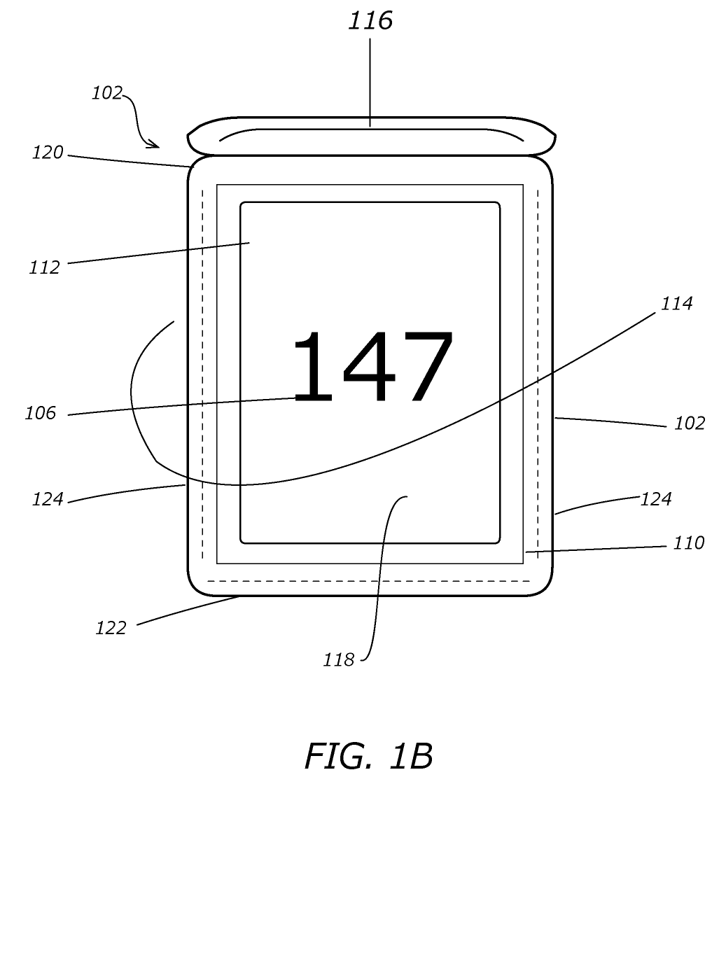

### FIG. 1A — Identification Display System

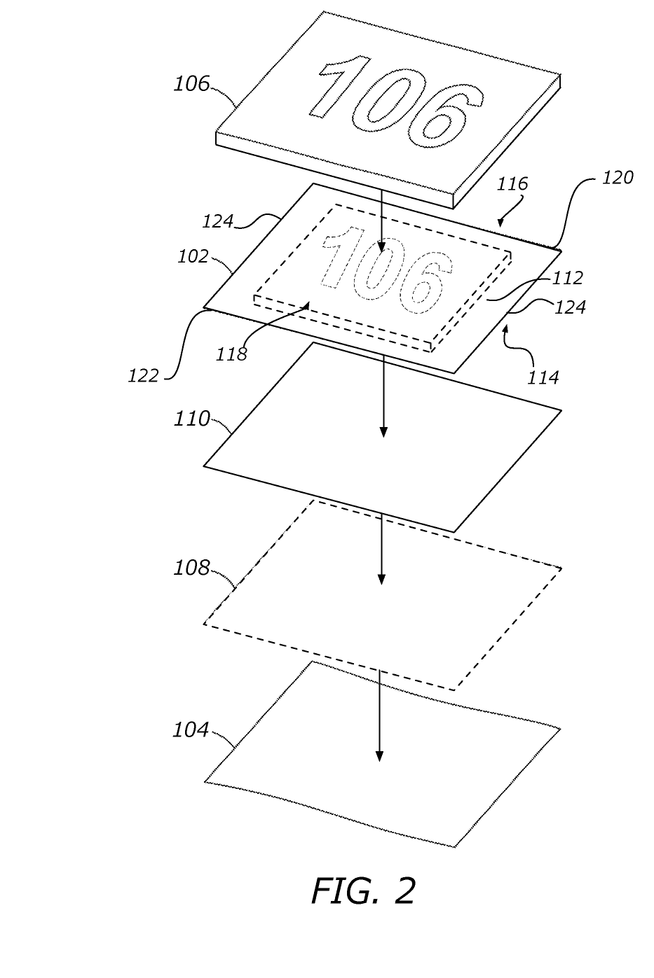

FIG. 1A illustrates an example identification display system 100, in accordance with various embodiments. As shown in FIG. 1A, identification display system 100 includes a display pocket 102 coupled to an apparel substrate 104 through an attachment interface 108. Display pocket 102 is operable to receive and retain an identification insert 106 in a visible orientation on apparel substrate 104. An optional frame or border layer 110 may surround or reinforce the perimeter of display pocket 102. Reference numbers are carried over between figures for similar components for purposes of simplicity of explanation, and such usage should not be construed as a limitation on the various embodiments unless otherwise stated. Display pocket 102 is further described in FIGS. 1B and 2.

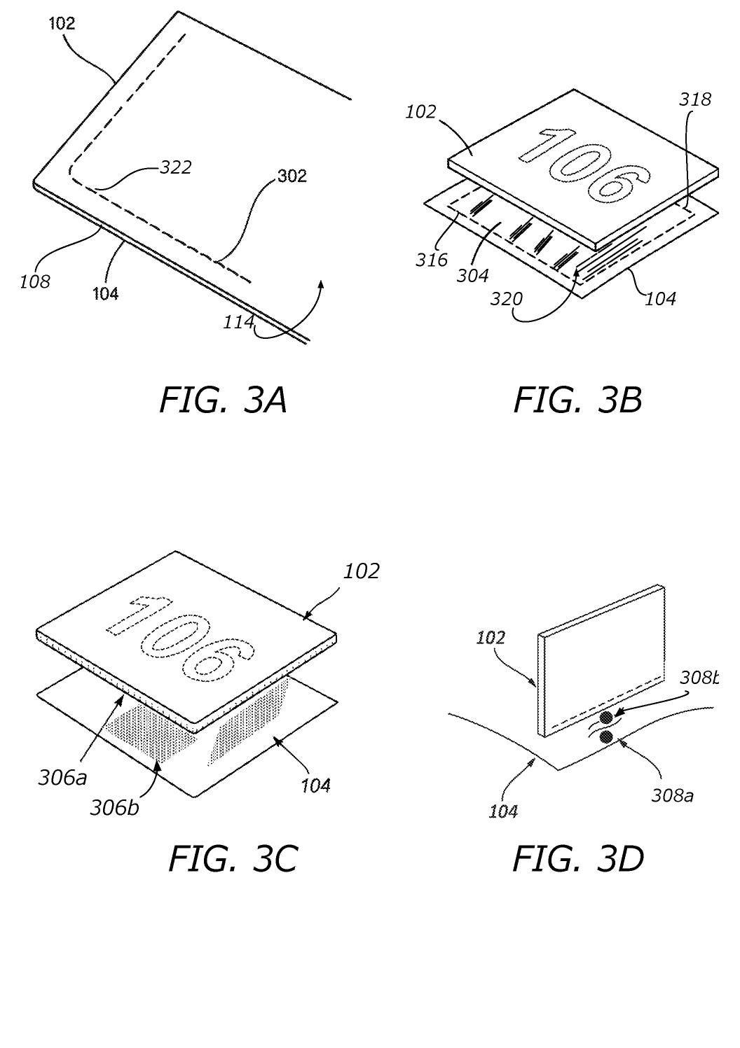

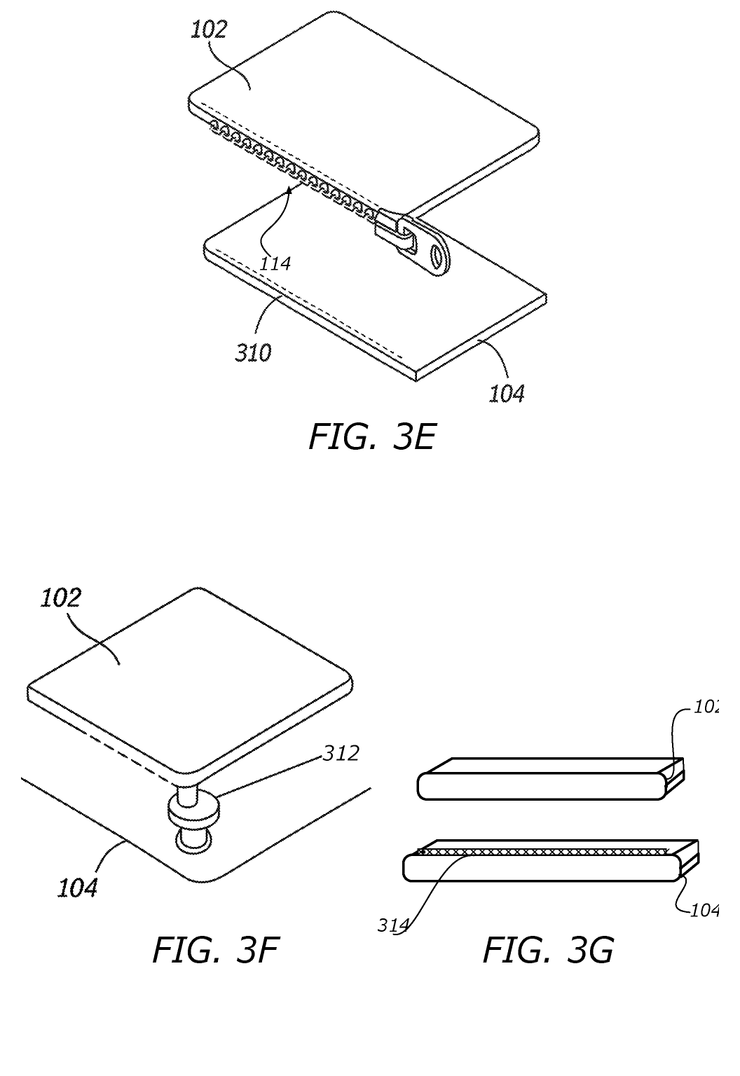

The components illustrated in FIG. 1A are presented by way of example and may be implemented in various combinations or configurations. In certain embodiments, display pocket 102, apparel substrate 104, identification insert 106, attachment interface 108, and frame or border layer 110 may be integrated, omitted, or substituted depending on application requirements. Attachment interface 108 may take a variety of forms including stitching, adhesive, magnetic, hook-and-loop, snap, zipper, and thermally-bonded variants, each further described in connection with FIGS. 3A-3G. Display pocket 102 may be integrated into apparel substrate 104 during garment manufacture, applied to an existing apparel substrate 104 by an end user, or provided as part of a kit for retrofit application to an existing garment.

### FIG. 1B — Display Pocket Three-Quarter View

FIG. 1B illustrates an example three-quarter perspective view of display pocket 102, in accordance with various embodiments. As shown in FIG. 1B, display pocket 102 includes front panel 112, rear panel 114 joined to front panel 112 along bottom edge 122 of display pocket 102 and along two side edges 124 of display pocket 102, and pocket opening 116 between front panel 112 and rear panel 114. Pocket opening 116 extends along upper edge 120 of display pocket 102 opposing bottom edge 122. Rear panel 114 is indicated in FIG. 1B by a ghost leader extending through front panel 112 to the rear-panel face obscured from view in the three-quarter perspective.

More specifically, FIG. 1B shows front panel 112 presenting viewing region 118 through which identification insert 106 is visible when identification insert 106 is received within display pocket 102. Upper edge 120 defines the top edge of display pocket 102 along which pocket opening 116 is positioned. Bottom edge 122 defines the lower edge of display pocket 102 at which front panel 112 and rear panel 114 are joined. Side edges 124 define two opposing lateral edges of display pocket 102 at which front panel 112 and rear panel 114 are joined, each side edge 124 extending between upper edge 120 and bottom edge 122. Pocket opening 116 is sized to receive identification insert 106 through pocket opening 116 in a direction from upper edge 120 toward bottom edge 122 and to accommodate withdrawal of identification insert 106 through pocket opening 116 in the opposite direction.

### Display Pocket 102

Display pocket 102 is operable to receive and retain identification insert 106 in a visible orientation on apparel substrate 104. Display pocket 102 is positioned on an exterior surface of apparel substrate 104 and presents a viewing region 118 through which identification insert 106 is visible when identification insert 106 is received within display pocket 102.

More specifically, display pocket 102 includes a front panel 112, a rear panel 114 joined to front panel 112 along a bottom edge 122 of display pocket 102 and along two side edges 124 of display pocket 102, and a pocket opening 116 between front panel 112 and rear panel 114. Pocket opening 116 extends along an upper edge 120 of display pocket 102 opposing bottom edge 122. Pocket opening 116 is sized to receive identification insert 106 through pocket opening 116. Front panel 112 includes viewing region 118 dimensioned to render identification insert 106 visible through front panel 112 after identification insert 106 is received between front panel 112 and rear panel 114.

For example, display pocket 102 may be formed from a transparent polymer film (e.g., thermoplastic polyurethane (TPU), polyvinyl chloride (PVC), or polyethylene terephthalate (PET)), a semi-transparent polymer film, a woven textile with a transparent window, or a composite laminate including a transparent viewing region 118 and a textile or polymer perimeter. Front panel 112 may be formed from an optically clear or substantially optically clear material over at least viewing region 118, and rear panel 114 may be formed from a transparent, semi-transparent, or opaque material. Rear panel 114 may match apparel substrate 104 in color or texture, or may contrast with apparel substrate 104 for visual emphasis. Display pocket 102 may be rectangular, square, rounded-rectangular, oval, or custom-shaped, and may be dimensioned to match an identification insert 106 of any practical size, including a rectangular insert between approximately 50 mm and approximately 200 mm on a side.

In certain embodiments, display pocket 102 may include more than one pocket opening 116. For example, a second pocket opening may be provided along one of side edges 124 or along bottom edge 122 to enable alternative insertion paths for identification insert 106, to enable simultaneous display of two identification inserts 106, or to enable insertion from either side. In certain embodiments, display pocket 102 may include an interior divider dividing an interior volume of display pocket 102 into two or more sub-cavities, each sub-cavity operable to receive a respective identification insert 106.

In certain embodiments, display pocket 102 may include reinforcement of upper edge 120 along pocket opening 116. The reinforcement of upper edge 120 may include a folded-over hem, a bound edge (e.g., a textile tape or polymer tape bonded along upper edge 120), a thermoformed bead along upper edge 120, or an additional layer of pocket material along upper edge 120. Reinforcement of upper edge 120 is operable to maintain the dimensional stability of pocket opening 116 across repeated insertion and removal cycles of identification insert 106.

### Apparel Substrate 104

Apparel substrate 104 is the garment article to which display pocket 102 is coupled. Apparel substrate 104 is operable to position display pocket 102 in a visible region on a wearer, typically a front torso, chest, back, shoulder, sleeve, or hip region.

More specifically, apparel substrate 104 includes a garment surface to which display pocket 102 is coupled through attachment interface 108. The garment surface may be an exterior surface of apparel substrate 104, an interior surface of apparel substrate 104 in embodiments in which display pocket 102 projects through a window in apparel substrate 104, or an interlining surface in multi-layer garment constructions. Apparel substrate 104 may include a single-layer textile, a multi-layer textile, or a textile-and-polymer laminate. Apparel substrate 104 may include reinforcement zones (e.g., an interlining patch behind the region at which display pocket 102 is coupled) operable to distribute load across apparel substrate 104 and resist fabric distortion under the weight or movement of display pocket 102 and identification insert 106.

For example, apparel substrate 104 may include a shirt, a jersey, a uniform top, a leotard, a dance costume, a vest, a jacket, a tank top, a bib, a sash, a competition top, a warm-up top, or an apron. Apparel substrate 104 may also include a lower-body garment (e.g., shorts, tights, pants, a skirt, or trousers), an accessory (e.g., a headband, wristband, armband, belt, or hat), or an overlay worn atop another garment. Apparel substrate 104 may be formed from cotton, polyester, nylon, spandex, rayon, bamboo fiber, wool, or blends thereof, and may include moisture-wicking, stretch, antimicrobial, or abrasion-resistant treatments.

### Identification Insert 106

Identification insert 106 is operable to present identification information in a visible orientation within display pocket 102. Identification insert 106 is received through pocket opening 116 and retained between front panel 112 and rear panel 114.

More specifically, identification insert 106 includes a planar substrate sized to fit within an interior volume of display pocket 102 with identification insert 106 visible through viewing region 118. Identification insert 106 includes one or more identification markings on a face of identification insert 106, the identification markings including an alphanumeric identifier (e.g., a competition number, a participant number, a role identifier, a team identifier, or a name), a symbolic identifier (e.g., a team logo, a studio insignia, or a role icon), a graphic identifier, a color-coded identifier, or a combination thereof. The identification markings may be positioned on a front face of identification insert 106, a rear face of identification insert 106, or both front and rear faces in embodiments in which display pocket 102 includes a transparent rear panel 114.

For example, identification insert 106 may be formed from cardstock, coated cardstock, laminated paper, polymer film (e.g., PET, polypropylene, or polycarbonate), synthetic paper, or a composite substrate. Identification markings may be applied by inkjet printing, laser printing, thermal printing, screen printing, engraving, embossing, pre-printing, handwriting (in embodiments in which identification insert 106 includes a writable surface), or a combination thereof. Identification insert 106 may be sized to approximate a standard card format (e.g., a 75 mm x 125 mm rectangle, a 100 mm x 150 mm rectangle, or a 125 mm x 175 mm rectangle) or may be custom-sized to match a given display pocket 102.

In certain embodiments, identification insert 106 may include a machine-readable code 702 on a face of identification insert 106. Machine-readable code 702 may include a linear barcode (e.g., a Code 128, Code 39, or EAN barcode), a two-dimensional barcode (e.g., a QR code, a Data Matrix code, an Aztec code, or a PDF417 code), or a wirelessly readable tag (e.g., a passive RFID tag or an NFC tag embedded within or affixed to identification insert 106). Machine-readable code 702 is operable to associate identification insert 106 with participant data maintained by an event-control system, such that a scanner or reader associated with the event-control system can identify a wearer of apparel substrate 104 by capturing machine-readable code 702. Machine-readable code 702 may be displayed alongside, behind, or in place of a human-readable identifier on identification insert 106.

In certain embodiments, identification insert 106 may include a dual-sided construction in which a first face of identification insert 106 carries a first identification marking and a second face of identification insert 106 carries a second identification marking. Identification insert 106 may be reversible within display pocket 102 to expose the first face or the second face through viewing region 118 as desired. Dual-sided constructions support use cases in which a participant's identifier changes between rounds of a competition, between roles within an event, or between events.

### Attachment Interface 108

Attachment interface 108 is operable to couple display pocket 102 to apparel substrate 104. Attachment interface 108 is positioned between rear panel 114 and the garment surface of apparel substrate 104 and is coupled to rear panel 114.

More specifically, attachment interface 108 retains display pocket 102 in a substantially fixed position on apparel substrate 104 during wear of apparel substrate 104. Attachment interface 108 is configured to resist detachment of display pocket 102 from apparel substrate 104 under tensile loads applied to apparel substrate 104 during active movement, perspiration exposure, and routine laundering, as applicable to the selected attachment interface 108. Attachment interface 108 may be co-extensive with rear panel 114 (e.g., extending across substantially the entire rear face of rear panel 114), may extend along a perimeter of rear panel 114, or may be applied at discrete locations along rear panel 114 (e.g., at corner regions, edge midpoints, or central anchor points).

For example, attachment interface 108 may include a stitched seam 302, an adhesive layer 304, a hook-and-loop component 306a or 306b, a magnetic element 308aor 308b, a snap component 312, a zipper 310, a thermally-bonded seam 314, or a combination thereof, each further described in connection with FIGS. 3A through 3G. Attachment interface 108 may be integrated during manufacture of apparel substrate 104 (for example, where attachment interface 108 includes stitched seam 302, thermally-bonded seam 314, or an adhesive layer 304 applied during garment manufacture), or may be applied to an existing apparel substrate 104 by an end user (for example, where attachment interface 108 includes an adhesive layer 304 pre-applied to rear panel 114 and protected by release liner 320, or a hook-and-loop component 306a engageable with a mating hook-and-loop component 306b already present on apparel substrate 104).

In certain embodiments, attachment interface 108 may include two or more distinct attachment mechanisms acting in combination. For example, attachment interface 108 may include a stitched seam 302 along a perimeter of rear panel 114 and a hook-and-loop component 306a on an interior region of rear panel 114, operable to both permanently couple rear panel 114 to apparel substrate 104 and releasably couple a secondary element (e.g., a decorative overlay or a branding panel) atop display pocket 102. Combinations may be selected to balance retention strength, removability, and aesthetics.

### Frame or Border Layer 110

Frame or border layer 110 is an optional structural element of identification display system 100 operable to surround, reinforce, visually delimit, or align display pocket 102. Frame or border layer 110 is positioned adjacent to rear panel 114, between rear panel 114 and apparel substrate 104, or along a perimeter of display pocket 102 exterior to front panel 112 and rear panel 114.

More specifically, frame or border layer 110 may define an opening sized to accommodate display pocket 102 such that viewing region 118 is exposed through frame or border layer 110. Frame or border layer 110 may be coupled to display pocket 102 along the perimeter of display pocket 102 by stitching, adhesive lamination, thermal bonding, or ultrasonic welding. Frame or border layer 110 may include alignment markings, branding regions, or decorative treatments (e.g., piping, contrast stitching, embroidered logos, reflective strips, or color-coded zones) along a viewable portion of frame or border layer 110.

For example, frame or border layer 110 may be formed from a woven textile tape, a coated textile tape, a TPU edge strip, a synthetic leather strip, a molded polymer frame, or a thermoplastic reinforcement panel. Frame or border layer 110 may include pre-applied adhesive on a rear face for user-installed applications, or may be stitched or ultrasonically welded into apparel substrate 104 during garment manufacture for factory-installed applications.

In certain embodiments, frame or border layer 110 may support additional structural or functional features. For example, frame or border layer 110 may house embedded fasteners (e.g., magnetic element 308a, snap component 312, or hook-and-loop component 306a) operable to couple display pocket 102 to apparel substrate 104 through frame or border layer 110 rather than through rear panel 114 directly. In embodiments in which display pocket 102 includes flexible display medium 902, frame or border layer 110 may house controller 906, a battery, a wireless communication module, or a flexible circuit trace operable to deliver power and control signals to flexible display medium 902.

In certain embodiments, frame or border layer 110 may be omitted. For example, where rear panel 114 is coupled directly to apparel substrate 104 through attachment interface 108 without additional perimeter support, frame or border layer 110 is not required. Omission of frame or border layer 110 may be appropriate for embodiments in which rear panel 114 is formed from a material of sufficient dimensional stability to resist edge curling or delamination without reinforcement.

### FIG. 2 — Exploded View

FIG. 2 illustrates an example exploded configuration of identification display system 100, in accordance with various embodiments. FIG. 2 depicts the spatial relationship among identification insert 106, display pocket 102, frame or border layer 110, attachment interface 108, and apparel substrate 104. As shown, identification insert 106 is positioned to be received within display pocket 102 through pocket opening 116 at upper edge 120. Display pocket 102 is positioned above frame or border layer 110, which in turn overlies attachment interface 108, which couples the assembly to apparel substrate 104. The exploded view emphasizes the layered structural arrangement of identification display system 100; in assembled form, the layers may be pressed, bonded, stitched, or otherwise joined into a unitary structure.

As shown in FIG. 2, display pocket 102 includes front panel 112 and rear panel 114 joined along bottom edge 122 and along two side edges 124 to define an interior volume. Pocket opening 116 extends along upper edge 120 of display pocket 102 between front panel 112 and rear panel 114. Viewing region 118 of front panel 112 is dimensioned to render identification insert 106 visible through front panel 112 when identification insert 106 is received between front panel 112 and rear panel 114.

More specifically, front panel 112 and rear panel 114 may be formed from a single folded sheet of pocket material folded along one of bottom edge 122 or side edges 124, with the remaining joined edges joined by stitching, thermal bonding, adhesive lamination, ultrasonic welding, or radio-frequency welding. Alternatively, front panel 112 and rear panel 114 may be formed from separate sheets of pocket material joined along bottom edge 122 and both side edges 124 by the same bonding techniques. In certain embodiments, front panel 112 and rear panel 114 may include material of differing composition. For example, front panel 112 may be formed from an optically clear polymer film over at least viewing region 118, and rear panel 114 may be formed from an opaque polymer film, a woven textile, a coated textile, or a laminate, selected based on the coupling requirements of attachment interface 108.

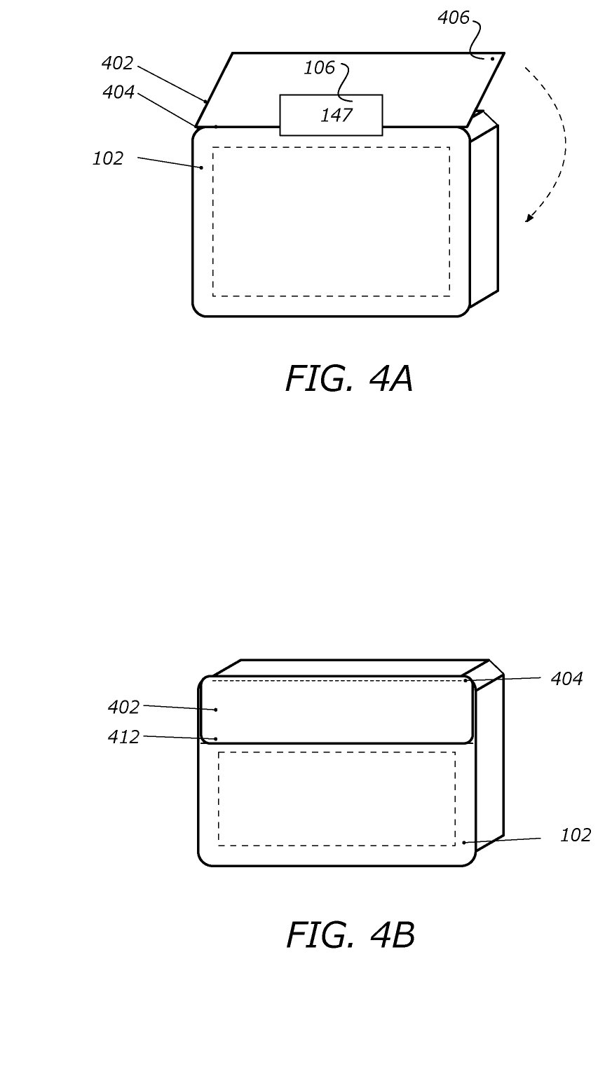

Pocket opening 116 is sized to receive identification insert 106 through pocket opening 116. Pocket opening 116 may be substantially equal in width to the interior width of display pocket 102 such that identification insert 106 can be inserted flat into display pocket 102, or may be narrower than the interior width of display pocket 102 to retain identification insert 106 by constraining the insert against shifting toward upper edge 120. Pocket opening 116 may be left unobstructed, may be reinforced along upper edge 120 to resist opening deformation, or may be covered by flap 402, as described in connection with FIGS. 4A and 4B.

Front panel 112 includes viewing region 118. Viewing region 118 is dimensioned to render identification insert 106 visible through front panel 112 when identification insert 106 is received between front panel 112 and rear panel 114. Viewing region 118 may span substantially the entirety of front panel 112, or may be limited to a sub-region of front panel 112 bordered by an opaque or semi-transparent perimeter of front panel 112. In certain embodiments, front panel 112 may include multiple viewing regions 118 arranged to expose multiple zones of identification insert 106 while concealing intervening zones (e.g., alignment marks or operator notations) from view.

Rear panel 114 is positioned opposite front panel 112 across the interior volume of display pocket 102. Rear panel 114 supports identification insert 106 from behind when identification insert 106 is received within display pocket 102 and provides a coupling surface for attachment interface 108. Rear panel 114 may be coupled directly to attachment interface 108 across substantially the entirety of an exterior face of rear panel 114, or attachment interface 108 may be coupled to rear panel 114 along a perimeter of rear panel 114, at discrete regions of rear panel 114, or along one or more edges of rear panel 114.

As shown in FIG. 2, frame or border layer 110 aligns with the perimeter of display pocket 102 between display pocket 102 and attachment interface 108. In embodiments including frame or border layer 110, frame or border layer 110 may be coupled to rear panel 114, to front panel 112, or to both, and may define an opening through which viewing region 118 is exposed. In embodiments omitting frame or border layer 110, rear panel 114 is coupled directly to attachment interface 108.

As shown in FIG. 2, attachment interface 108 is positioned between rear panel 114 (or frame or border layer 110, where present) and apparel substrate 104. Attachment interface 108 may be illustrated in FIG. 2 as a discrete layer to emphasize its role in coupling display pocket 102 to apparel substrate 104, but in certain embodiments attachment interface 108 is not a discrete layer. For example, where attachment interface 108 includes stitched seam 302, attachment interface 108 is formed by thread 322 passing through rear panel 114 and the garment surface of apparel substrate 104 rather than by an intermediate layer. Where attachment interface 108 includes thermally-bonded seam 314, attachment interface 108 is formed by thermal fusion of fusible material between rear panel 114 and the garment surface of apparel substrate 104 and becomes substantially integrated with rear panel 114 and the garment surface after bonding. Where attachment interface 108 includes adhesive layer 304, attachment interface 108 remains a discrete layer between rear panel 114 and the garment surface.

### FIG. 3A — Stitched-Seam Attachment

FIG. 3A illustrates an example stitched-seam attachment interface coupling display pocket 102 to apparel substrate 104, in accordance with various embodiments. As shown in FIG. 3A, attachment interface 108 includes stitched seam 302 extending along a perimeter of rear panel 114. Stitched seam 302 includes thread 322 passing through rear panel 114 and the garment surface of apparel substrate 104 along the perimeter.

More specifically, stitched seam 302 is operable to permanently couple display pocket 102 to apparel substrate 104 by mechanical interlock between thread 322 and the fiber structures of rear panel 114 and apparel substrate 104. Stitched seam 302 may follow a continuous perimeter pattern around rear panel 114, a discontinuous or interrupted pattern with periodic tacking stitches, a double-perimeter pattern with an inner and outer stitch line, or a cross-stitched corner pattern reinforcing corner regions where peel forces tend to concentrate. Stitched seam 302 may include one or more stitch types, including a straight stitch (e.g., a lockstitch or chain stitch), a zig-zag stitch, an overlock stitch, a decorative or contrast-color stitch, or a combination thereof, selected based on desired retention strength, garment aesthetics, and manufacturing equipment availability.

For example, thread 322 may include a polyester thread, a nylon thread, a cotton thread, a polyester-cotton blend thread, an elastomeric thread (e.g., a polyurethane or spandex-wrapped thread), or a water-resistant coated thread. Thread 322 may be color-matched to apparel substrate 104, to rear panel 114, or to frame or border layer 110, or may be selected in a contrasting color for decorative emphasis. Stitch density may range between approximately 4 stitches per centimeter and approximately 12 stitches per centimeter depending on fabric density and desired retention strength. Stitched seam 302 may be formed using industrial sewing equipment, including single-needle lockstitch machines, programmable pattern stitching machines, or computer-controlled embroidery machines, or may be formed using home sewing equipment in user-installed embodiments.

In certain embodiments, stitched seam 302 may be concealed beneath frame or border layer 110, a binding tape, or a decorative overlay. In certain embodiments, stitched seam 302 may be combined with an additional attachment mechanism, such as adhesive layer 304 applied across a central region of rear panel 114 with stitched seam 302 reinforcing the perimeter. Combined attachment mechanisms are operable to resist both peel forces at the perimeter and lift-off forces at the central region of display pocket 102.

### FIG. 3B — Adhesive Attachment

FIG. 3B illustrates an example adhesive-layer attachment interface coupling display pocket 102 to apparel substrate 104, in accordance with various embodiments. As shown in FIG. 3B, attachment interface 108 includes adhesive layer 304 disposed between rear panel 114 and the garment surface of apparel substrate 104. Adhesive layer 304 includes a fabric-contact face 316 bonded to the garment surface and a pocket-contact face 318 bonded to rear panel 114.

More specifically, adhesive layer 304 is operable to retain display pocket 102 on apparel substrate 104 under tensile load applied to apparel substrate 104 during wear. Adhesive layer 304 may be co-extensive with rear panel 114, may extend along a perimeter of rear panel 114, or may be applied in a discrete pattern of regions on rear panel 114 (e.g., corner regions, perimeter strips, or central anchor points). Adhesive layer 304 may include a pressure-sensitive adhesive (PSA), a heat-activated adhesive, a moisture-activated adhesive, or a combination thereof.

For example, adhesive layer 304 may be formed from a pressure-sensitive acrylic adhesive, a pressure-sensitive silicone adhesive, a hot-melt polyurethane adhesive, an ethylene-vinyl acetate (EVA) hot-melt adhesive, a polyolefin hot-melt adhesive, or a thermoplastic polyurethane film adhesive. Adhesive layer 304 may be provided as a continuous film, a patterned film (e.g., a cross-hatched, striped, or dotted pattern), a carrier-backed tape, or a sprayable coating. Adhesive layer 304 may include a carrier layer (e.g., a polyester film or a nonwoven textile) sandwiched between two adhesive faces, with fabric-contact face 316 optimized for bonding to textiles and pocket-contact face 318 optimized for bonding to the material of rear panel 114.

Pocket-contact face 318 is bonded to rear panel 114 by pre-application during manufacture of display pocket 102. Pocket-contact face 318 may be laminated to rear panel 114 by thermal lamination, ultrasonic bonding, or pressure-sensitive adhesion, forming a substantially permanent bond with rear panel 114. Fabric-contact face 316 is bonded to the garment surface of apparel substrate 104 by an application force applied between rear panel 114 and apparel substrate 104. Application force may be a manual pressing force (e.g., applied by a user pressing rear panel 114 against apparel substrate 104 for a predetermined dwell time) or a machine-applied force (e.g., applied by a heat press, a roller, or a vacuum bonding station during garment manufacture).

In certain embodiments, adhesive layer 304 may be protected by a release liner 320 prior to application of display pocket 102 to apparel substrate 104. Release liner 320 covers fabric-contact face 316 of adhesive layer 304 during storage, handling, and shipping of display pocket 102. Release liner 320 may include a silicone-coated paper, a silicone-coated polymer film (e.g., a PET or polypropylene film with a silicone release coating), a fluoropolymer-coated film, or another release-treated substrate operable to prevent adhesion of adhesive layer 304 to release liner 320 during storage and to release cleanly from adhesive layer 304 when removed prior to application. Release liner 320 is removed by a user or by a manufacturing process immediately prior to application of fabric-contact face 316 to apparel substrate 104.

### Adhesive Layer 304 — Residue-Free Release and Laundering Tolerance

In certain embodiments, adhesive layer 304 is formulated to retain display pocket 102 on apparel substrate 104 under a tensile load applied to apparel substrate 104 and to separate from the garment surface without visible adhesive residue on the garment surface. Residue-free separation is operable to enable reuse of apparel substrate 104 following removal of display pocket 102, a property particularly relevant to performance-oriented or high-value garments that a wearer intends to retain after an event.

More specifically, residue-free separation of adhesive layer 304 from the garment surface may be achieved by selecting an adhesive chemistry with cohesive strength greater than adhesive affinity to the garment surface, such that upon separation adhesive layer 304 remains attached to pocket-contact face 318 and cleanly releases from fabric-contact face 316 at the garment-surface interface. Adhesive chemistries operable to achieve residue-free separation include a removable-grade pressure-sensitive acrylic adhesive (e.g., an acrylic PSA with tack values in a removable-grade range), a silicone pressure-sensitive adhesive, a low-tack rubber-based adhesive, or a microstructured adhesive with engineered adhesion geometry (e.g., a gecko-type microstructure or a micro-pillar array).

For example, adhesive layer 304 may exhibit a 180-degree peel strength against a woven polyester substrate between approximately 2 N/25 mm and approximately 15 N/25 mm immediately after application, and a 180-degree peel strength against the same substrate substantially unchanged or moderately reduced after ten laundering cycles at approximately 40 degrees Celsius. Adhesive layer 304 may retain a tensile retention force sufficient to resist detachment of display pocket 102 from apparel substrate 104 during active movement representative of dance, athletic, or similar performance contexts (for example, sustained acceleration forces on display pocket 102 up to approximately 3 g during motion), and may separate from apparel substrate 104 by manual peeling applied at an acute angle between rear panel 114 and the garment surface without leaving a visually detectable residue on the garment surface under ordinary room lighting and inspection at approximately 30 centimeters.

In certain embodiments, adhesive layer 304 may be formulated for selective deactivation by exposure to a triggering condition. For example, adhesive layer 304 may include a thermally-deactivatable adhesive chemistry that softens and releases under heat above approximately 60 degrees Celsius (e.g., during a warm laundering cycle), a moisture-activated releasable chemistry that weakens upon extended exposure to water or laundering detergents, or a solvent-releasable chemistry that releases upon application of an isopropyl-alcohol or similar release agent. Triggering conditions support use cases in which display pocket 102 is intended for single-event use with subsequent clean removal during routine garment care.

Visible adhesive residue, for purposes of the foregoing functional performance, refers to a discoloration, gloss alteration, tactile tackiness, or particulate transfer detectable on the garment surface by ordinary visual inspection under room lighting at approximately 30 centimeters following removal of display pocket 102 from apparel substrate 104. Adhesive layer 304 formulated to separate without visible adhesive residue retains substantially all of its adhesive mass with pocket-contact face 318 upon removal, with no substantial transfer of adhesive mass to the garment surface.

### FIG. 3C — Hook-and-Loop Attachment

FIG. 3C illustrates an example hook-and-loop attachment interface coupling display pocket 102 to apparel substrate 104, in accordance with various embodiments. As shown in FIG. 3C, attachment interface 108 includes a first hook-and-loop component 306acoupled to rear panel 114 and a second hook-and-loop component 306b coupled to the garment surface of apparel substrate 104. First hook-and-loop component 306aand second hook-and-loop component 306b are releasably engageable to couple display pocket 102 to apparel substrate 104.

More specifically, first hook-and-loop component 306a includes a first field of mechanical engagement elements operable to releasably engage a second field of mechanical engagement elements of second hook-and-loop component 306b. In a representative configuration, first hook-and-loop component 306a includes a field of hooks formed from a polymer monofilament or polymer film, and second hook-and-loop component 306b includes a field of loops formed from a woven, knitted, or nonwoven textile. In an alternative configuration, first hook-and-loop component 306aincludes the field of loops and second hook-and-loop component 306b includes the field of hooks. In a further alternative configuration, both first hook-and-loop component 306a and second hook-and-loop component 306b include a field of mechanical engagement elements engageable with a mating field of the same type (e.g., a mushroom-head interlock, a stem-to-stem interlock, or a dual-locking fastener system).

For example, first hook-and-loop component 306a and second hook-and-loop component 306b may each include a nylon, polyester, or polypropylene textile or polymer film, and may be formed with low-profile hooks and loops (e.g., low-profile or ultra-thin hook-and-loop fasteners) for reduced bulk against apparel substrate 104. First hook-and-loop component 306amay be coupled to rear panel 114 by stitching, adhesive lamination, thermal bonding, or ultrasonic welding, and may extend along a perimeter of rear panel 114, across substantially the entirety of an exterior face of rear panel 114, or at discrete regions of rear panel 114. Second hook-and-loop component 306bmay be coupled to the garment surface of apparel substrate 104 by the same techniques, integrated during manufacture of apparel substrate 104 or applied in an after-market installation.

Hook-and-loop components 306aand 306bare operable to support repeated engagement and disengagement cycles of display pocket 102 on apparel substrate 104, enabling a user to reposition display pocket 102, replace display pocket 102 with a second display pocket 102, or detach display pocket 102 for storage or laundering of apparel substrate 104. In certain embodiments, hook-and-loop components 306a and 306b may be sized and positioned to permit rotational alignment of display pocket 102 on apparel substrate 104, allowing a user to orient display pocket 102 in a portrait or landscape orientation as desired.

### FIG. 3D — Magnetic Attachment

FIG. 3D illustrates an example magnetic attachment interface coupling display pocket 102 to apparel substrate 104, in accordance with various embodiments. As shown in FIG. 3D, attachment interface 108 includes a first magnetic element 308a coupled to rear panel 114 and a second magnetic element 308b coupled to the garment surface of apparel substrate 104. First magnetic element 308aand second magnetic element 308b are arranged to magnetically couple display pocket 102 to apparel substrate 104.

More specifically, first magnetic element 308a and second magnetic element 308b are arranged to generate a magnetic attraction force across apparel substrate 104 or across an intervening layer, operable to retain display pocket 102 on apparel substrate 104 against the shear and peel forces associated with active wear. In a representative configuration, first magnetic element 308a and second magnetic element 308b each include a permanent magnet, and the magnets are arranged with opposing magnetic polarities to generate attraction. In an alternative configuration, first magnetic element 308a includes a permanent magnet and second magnetic element 308b includes a ferromagnetic region (e.g., a steel disk, a nickel-coated steel disk, or a ferromagnetic foil), the permanent magnet operable to attract the ferromagnetic region across apparel substrate 104. In a further alternative configuration, first magnetic element 308a includes the ferromagnetic region and second magnetic element 308b includes the permanent magnet.

For example, first magnetic element 308a and second magnetic element 308b may each include a neodymium-iron-boron (NdFeB) permanent magnet, a samarium-cobalt permanent magnet, a ferrite permanent magnet, a flexible magnetic strip (e.g., a rubberized ferrite sheet), or an electromagnet in embodiments including a powered magnetic coupling. The magnets may be shaped as disks, squares, bars, rings, or flexible sheets, and may be sized to provide an attraction force sufficient to retain display pocket 102 against apparel substrate 104 under anticipated movement and insert loading conditions. First magnetic element 308aand second magnetic element 308b may be encapsulated within a polymer, textile, or metallic housing operable to protect the magnets from corrosion, mechanical damage, and user contact, and to prevent marring of apparel substrate 104.

First magnetic element 308a may be coupled to rear panel 114 by embedding within a laminated pocket of rear panel 114, by stitching a fabric sheath containing first magnetic element 308a to rear panel 114, by adhesive bonding a polymer housing containing first magnetic element 308a to rear panel 114, or by integrating first magnetic element 308a into frame or border layer 110. Second magnetic element 308bmay be coupled to the garment surface of apparel substrate 104 by stitching a fabric sheath to apparel substrate 104, by sealing second magnetic element 308b between layers of apparel substrate 104 in a multi-layer garment construction, or by affixing a patch containing second magnetic element 308b to an interior surface of apparel substrate 104 opposite the intended location of display pocket 102.

In certain embodiments, the magnetic attachment interface may include a shielding layer operable to direct the magnetic field toward the opposing magnetic element and to reduce interference with wearable electronic devices, identification tags, or transit cards carried by a wearer. The shielding layer may include a mu-metal foil, a steel plate, or a polymer-metal composite positioned on a back face of first magnetic element 308a, second magnetic element 308b, or both.

### FIG. 3E — Zipper Attachment

FIG. 3E illustrates an example zipper-based attachment interface coupling display pocket 102 to apparel substrate 104, in accordance with various embodiments. As shown in FIG. 3E, attachment interface 108 includes a zipper 310 joining display pocket 102 to apparel substrate 104. Zipper 310 is operable to reversibly couple display pocket 102 to apparel substrate 104 along a track defined by zipper 310.

More specifically, zipper 310 may extend along a portion of the perimeter of display pocket 102 or along substantially the entire perimeter of display pocket 102. Zipper 310 may include a first zipper half coupled to rear panel 114 (or to frame or border layer 110) and a second zipper half coupled to the garment surface of apparel substrate 104. A zipper slider engages the first zipper half and the second zipper half to couple or decouple display pocket 102 from apparel substrate 104 along the track. Zipper 310 may include teeth formed from a polymer (e.g., a polyester molded tooth, a polyacetal tooth, or a nylon coil), a metal (e.g., brass or aluminum teeth), or a hybrid of the foregoing, selected based on strength, flexibility, weight, and aesthetic requirements.

For example, zipper 310 may include a coil zipper, a molded plastic zipper, an invisible zipper, a water-resistant coated zipper, or a magnetic-assisted zipper hybrid. Zipper 310 may be configured with an auto-lock slider operable to retain the slider against unintentional motion during wear, a concealed slider for discreet appearance, or a two-way slider operable to open the track from either end. Zipper 310 may be oriented substantially horizontally along a top edge of display pocket 102, substantially vertically along a side edge, or diagonally, depending on garment cut and display pocket placement.

In certain embodiments, zipper 310 may couple display pocket 102 to apparel substrate 104 along a perimeter of display pocket 102 and additionally define a reclosable opening to the interior volume of display pocket 102. For example, a first zipper 310 may couple display pocket 102 to apparel substrate 104 along bottom edge 122 and side edges 124, and a second zipper 310 may define a reclosable pocket opening 116 along upper edge 120. In certain embodiments, zipper 310 may be concealed beneath frame or border layer 110, a fabric flap, or a textile binding to reduce visual prominence.

### FIG. 3F — Snap Attachment

FIG. 3F illustrates an example snap-based attachment interface coupling display pocket 102 to apparel substrate 104, in accordance with various embodiments. As shown in FIG. 3F, attachment interface 108 includes a snap component 312 coupled to rear panel 114 and a mating connector element coupled to the garment surface of apparel substrate 104. Snap component 312 includes a male connector element or a female connector element, and mating connector element includes the complementary element.

More specifically, snap component 312 and mating connector element are arranged to mechanically engage by pressing snap component 312 against mating connector element to form a snap connection. The snap connection is operable to retain display pocket 102 against apparel substrate 104 and is releasable by applying a separation force sufficient to disengage snap component 312 from mating connector element. Snap component 312 and mating connector element may include a prong snap, a ring snap, a post snap, a spring-loaded snap, a magnetically-assisted snap, or a keyed-alignment snap.

For example, snap component 312 and mating connector element may be formed from stainless steel, brass, nickel-plated steel, aluminum, zinc alloy, or acetal resin. Snap component 312 and mating connector element may be riveted to their respective substrates, stitched to their respective substrates via a flanged base, or molded into a polymer base adhered to their respective substrates. A plurality of snap components 312 and mating connector elements may be distributed around a perimeter of display pocket 102 (e.g., at each corner of a rectangular display pocket 102, at corner and edge-midpoint positions, or in a grid pattern across rear panel 114) to distribute attachment forces and resist edge lifting or rotation of display pocket 102 during wear.

In certain embodiments, snap component 312 and mating connector element may be reinforced at the apparel substrate 104 interface by a backing reinforcement (e.g., a fabric grommet, an interlining patch, or a polymer washer) operable to distribute mechanical stress and resist garment-surface tearing during repeated engagement and disengagement cycles. In certain embodiments, snap component 312 may be combined with magnetic element 308aor hook-and-loop component 306a to provide primary mechanical retention through the snap connection while magnetic element 308aor hook-and-loop component 306a assists with alignment prior to snap engagement.

### FIG. 3G — Thermally-Bonded Seam

FIG. 3G illustrates an example thermally-bonded seam coupling display pocket 102 to apparel substrate 104, in accordance with various embodiments. As shown in FIG. 3G, attachment interface 108 includes a thermally-bonded seam 314 between rear panel 114 and the garment surface of apparel substrate 104. Thermally-bonded seam 314 is formed by thermal fusion of a fusible material between rear panel 114 and the garment surface.

More specifically, fusible material is positioned between rear panel 114 and the garment surface of apparel substrate 104 prior to thermal bonding. Fusible material softens or melts under an applied heat and pressure and forms a substantially continuous bond with rear panel 114 and with the garment surface upon cooling. Thermally-bonded seam 314 is operable to permanently couple display pocket 102 to apparel substrate 104 by a substantially continuous layer of fused material between rear panel 114 and the garment surface.

For example, fusible material may include a thermoplastic polyurethane (TPU) film, an ethylene-vinyl acetate (EVA) film, a polyester hot-melt film, a polyamide hot-melt film, or a co-extruded multi-layer hot-melt film. Fusible material may be provided as a discrete film placed between rear panel 114 and the garment surface prior to bonding, as a pre-applied coating on an exterior face of rear panel 114, or as a pre-applied coating on the garment surface of apparel substrate 104. Fusible material may be substantially co-extensive with rear panel 114, may extend along a perimeter of rear panel 114, or may be applied in a patterned manner (e.g., a gridded, striped, or dotted pattern) to control the distribution of the bonded region.

Thermally-bonded seam 314 may be formed by applying heat and pressure to rear panel 114 against apparel substrate 104 using a heat press, an iron, a continuous-press lamination station, an ultrasonic bonding station, or a radio-frequency welding station. Bonding temperature, bonding time, and bonding pressure are selected based on the composition of fusible material, the heat tolerance of rear panel 114, and the heat tolerance of apparel substrate 104. In a representative configuration, fusible material may be bonded at temperatures between approximately 110 degrees Celsius and approximately 180 degrees Celsius for bonding times between approximately 5 seconds and approximately 30 seconds at bonding pressures sufficient to ensure substantially uniform contact across the intended bond area.

In certain embodiments, thermally-bonded seam 314 may be combined with an additional attachment mechanism to distribute mechanical stress across rear panel 114. For example, thermally-bonded seam 314 may be formed across a central region of rear panel 114 with stitched seam 302 reinforcing the perimeter, or thermally-bonded seam 314 may be formed along a perimeter of rear panel 114 with adhesive layer 304 supporting a central region of rear panel 114.

### Combinations and Substitutions

The embodiments illustrated in FIGS. 3A through 3G may be selected based on the intended application of identification display system 100, the construction of apparel substrate 104, the frequency of display pocket 102 replacement or removal, and manufacturing considerations. Stitching, adhesive bonding, and thermally-bonded seam variants are operable to permanently or semi-permanently couple display pocket 102 to apparel substrate 104 during garment manufacture. Hook-and-loop, magnetic, zipper, and snap variants are operable to removably or reversibly couple display pocket 102 to apparel substrate 104 for reuse across multiple garments, repositioning, or post-event laundering.

In certain embodiments, two or more of the attachment mechanisms of FIGS. 3A-3G may be used in combination. For example, an embodiment may include stitched seam 302 along a perimeter of rear panel 114 and adhesive layer 304 across a central region of rear panel 114; another embodiment may include first magnetic element 308aand second magnetic element 308b providing primary retention with a snap component 312 and mating connector element providing secondary alignment. Combinations of attachment mechanisms are operable to balance retention strength, removability, aesthetic integration, and manufacturing complexity.

### FIGS. 4A and 4B — Flap

FIGS. 4A and 4B illustrate an example flap 402 coupled along upper edge 120 of display pocket 102, in accordance with various embodiments. FIG. 4A illustrates flap 402 in a first position exposing pocket opening 116. FIG. 4B illustrates flap 402 in a second position covering pocket opening 116, with a closure-retention feature 412 arranged along a closed edge of flap 402 opposite fixed edge 404. Flap 402 is operable to protect pocket opening 116, to retain identification insert 106 within display pocket 102 against accidental dislodgement through pocket opening 116, or both.

More specifically, flap 402 is coupled to display pocket 102 at a fixed edge 404 of flap 402. Fixed edge 404 extends along upper edge 120 of display pocket 102 and is coupled to front panel 112, rear panel 114, frame or border layer 110, or a combination thereof, by stitching, adhesive bonding, thermal bonding, ultrasonic welding, or integrated formation (e.g., where flap 402 is integrally formed as a continuation of one of front panel 112 or rear panel 114). Flap 402 includes a free edge 406 opposite fixed edge 404. Flap 402 is foldable about fixed edge 404 between the first position and the second position. In the first position, free edge 406 is positioned away from pocket opening 116, exposing pocket opening 116 for insertion or removal of identification insert 106. In the second position, free edge 406 is positioned toward bottom edge 122, with flap 402 covering pocket opening 116.

For example, flap 402 may be formed from a textile, a polymer film, a coated textile, a synthetic leather, or a composite laminate, and may be substantially co-extensive with pocket opening 116 in width. Flap 402 may include a rectangular, trapezoidal, rounded, or custom profile, and may extend between approximately 10 mm and approximately 60 mm from fixed edge 404 to free edge 406. Flap 402 may match or contrast with front panel 112 in color and material, and may include branding, a logo, or a decorative treatment on an exterior face of flap 402 visible in the second position.

In certain embodiments, flap 402 may rely on gravity, friction, or a combination thereof to remain in the second position during wear. For example, in embodiments in which flap 402 is formed from a textile with sufficient areal weight, the weight of flap 402 may hold flap 402 against front panel 112 in the second position during typical wear. In embodiments in which front panel 112 includes a textured friction surfaces 602 and 606 or a tacky surface on its exterior face, flap 402 may remain against front panel 112 by friction in the second position.

In certain embodiments, flap 402 may include a closure mechanism operable to releasably retain flap 402 in the second position. The closure mechanism may include a snap connection between flap 402 and front panel 112 (e.g., a snap component at free edge 406 engageable with a mating connector element on front panel 112), a hook-and-loop closure between flap 402 and front panel 112, a magnetic closure between flap 402 and front panel 112, a button closure, or a tuck-in feature in which free edge 406 of flap 402 is insertable behind a retaining strip on front panel 112. The closure mechanism is operable to retain flap 402 in the second position against inadvertent displacement during active movement.

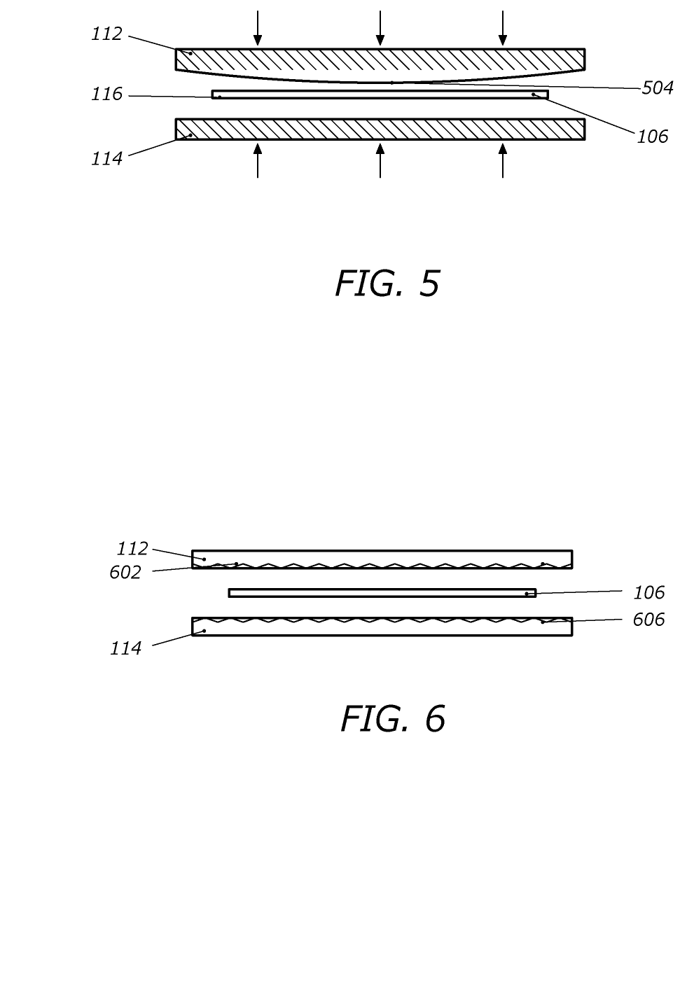

### FIG. 5 — Pressure-Fit Configuration

FIG. 5 illustrates an example pressure-fit configuration of display pocket 102, in accordance with various embodiments. As shown in FIG. 5, front panel 112 and rear panel 114 are biased toward each other along pocket opening 116 to define a pressure-fit region 504. Pressure-fit region 504 is arranged to form a pressure fit against identification insert 106 received between front panel 112 and rear panel 114.

More specifically, front panel 112 and rear panel 114 exhibit an unloaded spacing across the interior volume of display pocket 102 that is less than a thickness of identification insert 106 at pocket opening 116. When identification insert 106 is received through pocket opening 116, identification insert 106 displaces front panel 112 and rear panel 114 outwardly against the bias, and the bias applies a compressive force to identification insert 106 across pocket opening 116 and within the interior volume of display pocket 102. The compressive force is operable to retain identification insert 106 within display pocket 102 against gravitational and dynamic forces experienced during wear of apparel substrate 104.

For example, the bias between front panel 112 and rear panel 114 may be established by one or more mechanisms including an elastic constriction of pocket opening 116 (e.g., a narrowed region of pocket opening 116 substantially along upper edge 120), a folded or rolled hem along upper edge 120 that preloads front panel 112 and rear panel 114 against each other, an elastic band embedded within or along upper edge 120 operable to urge front panel 112 and rear panel 114 toward each other, or a folded construction in which front panel 112 and rear panel 114 are formed from a single sheet of pocket material preloaded by its folded geometry. The bias may be uniform along pocket opening 116 or may vary (e.g., with higher bias concentrated at a central region of pocket opening 116 and lower bias at side edges 124 to facilitate edge insertion of identification insert 106).

In certain embodiments, the bias may be provided by material selection. For example, at least one of front panel 112 and rear panel 114 may be formed from a resiliently flexible material (e.g., an elastomeric polymer, a stretch-knit textile with elastomeric fiber content, or a laminate including an elastomeric layer) that deflects against identification insert 106 and stores elastic energy operable to apply the compressive force. In certain embodiments, the pressure fit may be supplemented by textured friction surfaces 602 and 606 on an interior face of at least one of front panel 112 and rear panel 114 to combine compressive and frictional retention.

In certain embodiments, the bias may be engineered to define a retention force within a target range appropriate to the anticipated dimensions and weight of identification insert 106. For example, the bias may be selected to apply a net retention force between approximately 0.5 N and approximately 5 N to identification insert 106 received within display pocket 102, sufficient to resist dislodgement during anticipated active movement while remaining low enough to enable manual removal of identification insert 106 without damage to identification insert 106, front panel 112, or rear panel 114.

### FIG. 6 — Friction-Fit Configuration

FIG. 6 illustrates an example friction-fit configuration of display pocket 102, in accordance with various embodiments. As shown in FIG. 6, an interior face of front panel 112 includes textured friction surface 602, an interior face of rear panel 114 includes textured friction surface 606, or both. Textured friction surfaces 602 and 606 is arranged to engage identification insert 106 received between front panel 112 and rear panel 114 through friction to retain identification insert 106.

More specifically, textured friction surfaces 602 and 606 is formed on the interior face of front panel 112 (identified as textured friction surface 602 in certain embodiments), the interior face of rear panel 114 (identified as textured friction surface 606 in certain embodiments), or both. Textured friction surfaces 602 and 606 includes a plurality of surface features operable to increase the coefficient of friction between the interior face of the associated panel and a face of identification insert 106 in contact with the interior face. Textured friction surfaces 602 and 606 is operable to retain identification insert 106 against sliding motion within display pocket 102 under the dynamic forces experienced during wear of apparel substrate 104.

For example, textured friction surfaces 602 and 606 may include raised micro-ridges, a micro-cross-hatch pattern, a micro-dot pattern, a dimpled surface, a hair-cell or brushed texture, a matte surface, a flocked surface (e.g., a velvet-like flocking layer), a tacky polymer coating (e.g., a silicone or polyurethane coating with elevated tack), or a field of elastomeric bumps or protrusions. Textured friction surfaces 602 and 606 may be formed during manufacture of front panel 112 or rear panel 114 by texturing the panel material itself (e.g., embossing the polymer film during extrusion or casting), or may be applied as a secondary layer on the interior face of the panel after panel formation (e.g., by screen-printing a tacky coating, laminating a textured film, or adhering a flocked or textured patch).

In certain embodiments, textured friction surfaces 602 and 606 may be arranged in a discrete pattern to localize frictional retention at specific regions of the interior face. For example, textured friction surfaces 602 and 606 may be positioned substantially along side edges 124 of display pocket 102 to resist lateral shifting of identification insert 106 while leaving a central region of the interior face substantially smooth to avoid interference with viewing region 118. In certain embodiments, textured friction surfaces 602 and 606 may extend across substantially the entirety of the interior face of one or both panels to distribute frictional retention across the full face of identification insert 106.

In certain embodiments, textured friction surfaces 602 and 606 may be provided on only one of front panel 112 and rear panel 114, with the opposing panel remaining substantially smooth. In such embodiments, textured friction surfaces 602 and 606 may be provided on the interior face of rear panel 114, where the frictional surface does not interfere with visibility of identification insert 106 through viewing region 118 of front panel 112. In alternative embodiments, textured friction surfaces 602 and 606 may be provided on the interior face of front panel 112 outside viewing region 118, or may be provided on both interior faces for enhanced retention.

In certain embodiments, textured friction surfaces 602 and 606 may be combined with the bias-to-pressure-fit arrangement described in connection with FIG. 5 and with the flap 402 described in connection with FIGS. 4A and 4B. Combined retention mechanisms are operable to retain identification insert 106 across a broader range of movement conditions, identification insert materials, and environmental conditions.

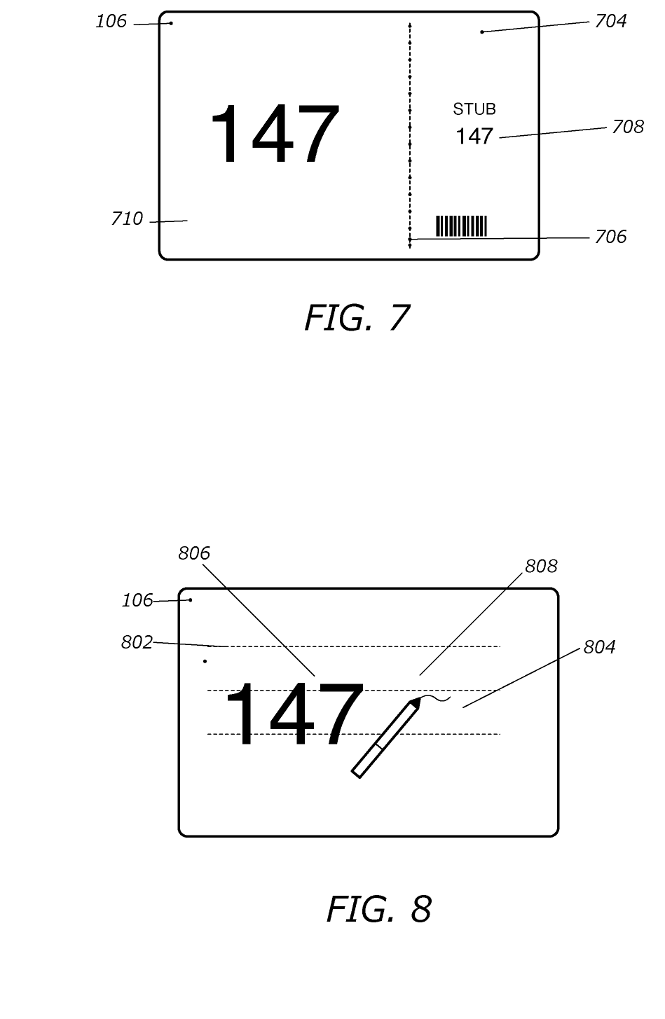

### FIG. 7 — Tear-Away Identification Insert

FIG. 7 illustrates an example tear-away identification insert, in accordance with various embodiments. As shown in FIG. 7, identification insert 106 includes a perforated tear line 706 separable under a tearing force to detach a tear-away stub 704 comprising a portion 708 of identification insert 106 from a remainder 710 of identification insert 106. Remainder 710 is retained between front panel 112 and rear panel 114 after detachment of portion 708 from identification insert 106.

More specifically, perforated tear line 706 extends across identification insert 106 between portion 708 and remainder 710. Perforated tear line 706 includes a plurality of perforations arranged along a line, a plurality of pre-scored regions, a plurality of weakened regions formed by laser ablation or mechanical scoring, or a combination thereof, operable to define a predetermined separation path between portion 708 and remainder 710. Perforated tear line 706 provides a structural weakness along the separation path sufficient to enable manual separation of portion 708 from remainder 710 under a tearing force applied by a user, while preserving the mechanical integrity of portion 708 and remainder 710 in unseparated form.

For example, perforated tear line 706 may include round perforations, slot perforations, or micro-perforations at a spacing between approximately 0.5 mm and approximately 5 mm along the separation path. Perforated tear line 706 may be formed during manufacture of identification insert 106 by die cutting, laser cutting, scoring, or needle-punching. Perforated tear line 706 may be oriented substantially horizontally across identification insert 106, substantially vertically, diagonally, or along a custom profile, and may be located at a position corresponding to a particular portion of identification insert 106 designated for removal.

In certain embodiments, portion 708 and remainder 710 may each support distinct identification markings. For example, portion 708 may support a first identification marking (e.g., a round identifier or a preliminary-heat identifier) and remainder 710 may support a second identification marking (e.g., a base participant identifier); upon separation of portion 708 from remainder 710, the second identification marking remains visible through viewing region 118 while the first identification marking is removed. In certain embodiments, identification insert 106 may include a plurality of perforated tear lines 706 defining a plurality of successive separable portions, such that portions of identification insert 106 may be detached sequentially as an event progresses.

In certain embodiments, identification insert 106 may include a stacked or layered construction in which a first layer of identification insert 106 is removable via perforated tear line 706 to expose a second layer of identification insert 106 behind the first layer. The second layer may be pre-staged with a secondary identifier that becomes visible through viewing region 118 upon removal of the first layer. Stacked constructions support use cases in which a series of identifiers is pre-assigned and revealed progressively during an event.

Identification insert 106 may be formed from a substrate selected to support the tearing action of perforated tear line 706. For example, identification insert 106 may be formed from cardstock, coated cardstock, synthetic paper (e.g., polypropylene-based synthetic paper), or a laminated paper-polymer substrate, with weight and composition selected to balance rigidity during insertion and ease of tearing along perforated tear line 706.

### FIG. 8 — Re-Writable Identification Insert

FIG. 8 illustrates an example re-writable identification insert, in accordance with various embodiments. As shown in FIG. 8, identification insert 106 includes a re-writable surface 804 with writable-surface guide lines 802. Re-writable surface 804 includes a first region 806 supporting a first identification marking and a second region 808 supporting a second identification marking. The first identification marking and the second identification marking are replaceable by rewriting re-writable surface 804.

More specifically, re-writable surface 804 includes a substrate operable to receive identification markings from a marking instrument, to retain the identification markings during wear of apparel substrate 104, and to release the identification markings upon application of an erasing action to re-writable surface 804. First region 806 and second region 808 may occupy distinct portions of re-writable surface 804 (e.g., a left half and a right half, an upper half and a lower half, or two geometric zones) or may occupy overlapping portions of re-writable surface 804 rewritten at different times.

For example, re-writable surface 804 may include a dry-erase surface operable to receive ink from a dry-erase marker, a wet-erase surface operable to receive ink from a wet-erase marker, a chalkboard surface operable to receive chalk markings, a thermochromic surface operable to selectively darken under localized heating, or a rewritable thermal surface operable to change optical state under thermal patterning. Re-writable surface 804 may be formed as a coating on a front face of identification insert 106 (e.g., a melamine-resin coating, a polyester topcoat, a polyurethane topcoat, a porcelain enamel coating, or a specialty rewritable coating), as a laminated film on a front face of identification insert 106, or as a monolithic rewritable substrate forming identification insert 106.

In certain embodiments, re-writable surface 804 may be provided on a top face of identification insert 106 facing front panel 112 such that identification markings on re-writable surface 804 are visible through viewing region 118 of front panel 112. In certain embodiments, re-writable surface 804 may extend across substantially the entire front face of identification insert 106 or may occupy a designated zone of the front face bordered by a non-rewritable region. In certain embodiments, identification insert 106 may include re-writable surface 804 on a front face and a printed or pre-applied identifier on a rear face, supporting dual-identifier embodiments in which the wearer can update one identifier while preserving the other.

In certain embodiments, the replacement of the first identification marking by the second identification marking occurs by erasing the first identification marking from re-writable surface 804 and writing the second identification marking on re-writable surface 804 in the same region or in a different region. In certain embodiments, identification insert 106 may be removed from display pocket 102 for rewriting, and re-inserted into display pocket 102 following application of the second identification marking. In certain embodiments, identification insert 106 may be rewritten in place within display pocket 102, by withdrawing identification insert 106 partially through pocket opening 116 to expose re-writable surface 804 to a marking instrument and returning identification insert 106 to the fully inserted position after rewriting.

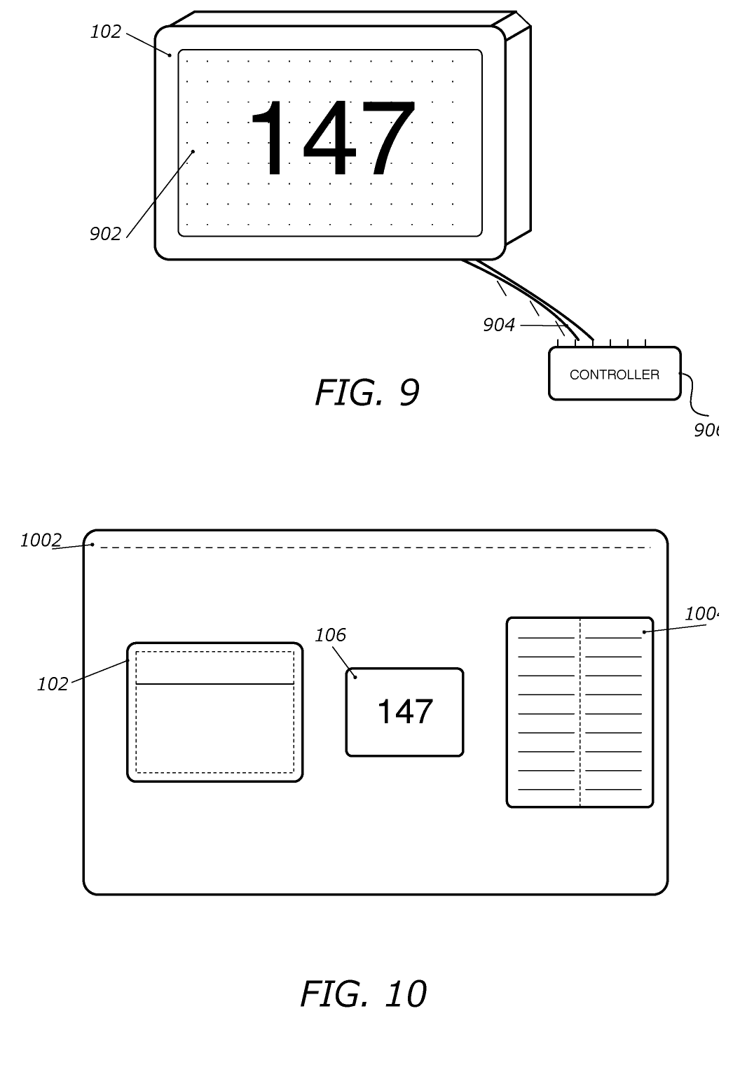

### FIG. 9 — Flexible Display Medium Configuration

FIG. 9 illustrates an example flexible display medium configuration of display pocket 102, in accordance with various embodiments. As shown in FIG. 9, display pocket 102 further includes a flexible display medium 902 operable to render alphanumeric identification data. Flexible display medium 902 is electrically coupled to controller 906 through an interconnect 904.

More specifically, flexible display medium 902 is integrated with, laminated to, or positioned within the interior volume of display pocket 102 to render identification data visible through viewing region 118 of front panel 112. Flexible display medium 902 is electrically coupled to controller 906 through one or more electrical conductors (e.g., a flexible printed circuit, a conductive textile trace, or discrete wires). Controller 906 is operable to drive flexible display medium 902 to display selected alphanumeric, graphic, or symbolic content, and to update the displayed content on command.

For example, flexible display medium 902 may include an electrophoretic display panel (e.g., an e-paper display), an electrochromic display panel, a liquid-crystal display (LCD) panel with a flexible substrate, an organic light-emitting diode (OLED) panel with a flexible substrate, a segmented light-emitting diode (LED) panel, an electronic ink display, or a reflective bistable display. Flexible display medium 902 may be sized to occupy substantially the entirety of front panel 112, to occupy viewing region 118 alone, or to occupy a portion of front panel 112 with a conventional transparent window exposing an additional identification insert 106 over the remainder of front panel 112.

Controller 906 may include a microcontroller, a display driver integrated circuit, a system-on-chip, or a combination thereof, coupled to flexible display medium 902 and operable to generate drive signals for flexible display medium 902. Controller 906 may be housed within frame or border layer 110, within a pocket region of rear panel 114, within a clip-on module that couples to display pocket 102, or within a separate enclosure carried or worn by a wearer and electrically coupled to flexible display medium 902 through a cable, a flexible circuit, or a snap-fit connector.

In certain embodiments, flexible display medium 902 and controller 906 are powered by a power source. The power source may include a rechargeable battery (e.g., a lithium-ion polymer battery or a solid-state thin-film battery), a primary battery (e.g., a coin-cell lithium battery), a wireless power receiver (e.g., a resonant-inductive or near-field wireless power coil), a photovoltaic cell, an energy-harvesting device (e.g., a piezoelectric harvester or thermoelectric harvester), or a combination thereof. The power source may be housed within frame or border layer 110, within a removable module coupled to display pocket 102, or within an enclosure separate from display pocket 102.

In certain embodiments, controller 906 is communicatively coupled to an external identification-management system operable to update the displayed content on flexible display medium 902 remotely. Controller 906 may include a wireless communication interface (e.g., a Bluetooth Low Energy transceiver, a near-field communication (NFC) transceiver, a Wi-Fi transceiver, or a proprietary low-power radio transceiver) operable to receive updated identification data from the external identification-management system. Controller 906 may alternatively receive updated identification data through a wired interface (e.g., a USB interface or a proprietary docking interface) upon physical connection to a docking station.

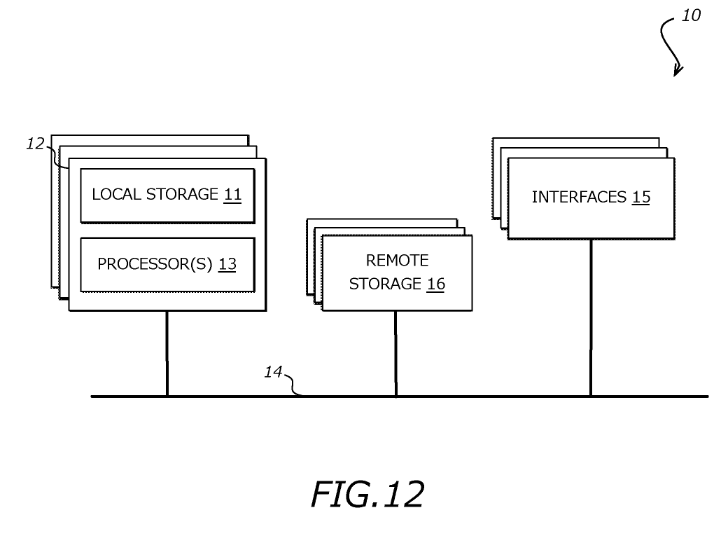

In certain embodiments, controller 906 may execute an identification-management process operable to coordinate the displayed content with one or more event-control conditions. For example, controller 906 may update flexible display medium 902 to display a first participant identifier during a first round of an event, and may update flexible display medium 902 to display a second participant identifier during a second round of the event, in response to update instructions received from an external event-management system. Example computing, networking, memory, and display-driver architectures operable to support controller 906 and flexible display medium 902 are described in connection with FIGS. 12-15.

### FIG. 10 — Kit

FIG. 10 illustrates an example kit including a display pocket, an identification insert, and installation instructions, in accordance with various embodiments. As shown in FIG. 10, the kit includes display pocket 102, identification insert 106, and a set of installation instructions 1002. Installation instructions 1002 describe a process for coupling display pocket 102 to an apparel substrate 104 through attachment interface 108.

More specifically, the kit includes identification insert 106 received through pocket opening 116 and retained between front panel 112 and rear panel 114 of display pocket 102, or includes display pocket 102 and identification insert 106 packaged separately for assembly by a user. The kit further includes installation instructions 1002 printed on a sheet, a booklet, a card, a label, or a package surface, or provided electronically (e.g., via a quick response (QR) code on a package surface linking to an online instruction set). Installation instructions 1002 set forth a process by which a user couples display pocket 102 to a user-provided apparel substrate 104 through attachment interface 108.

For example, where attachment interface 108 includes adhesive layer 304 with release liner 320, installation instructions 1002 may direct a user to clean a surface region of apparel substrate 104 intended to receive display pocket 102, to remove release liner 320 from fabric-contact face 316 of adhesive layer 304, to position rear panel 114 against the surface region with adhesive layer 304 therebetween, and to apply an application force for a predetermined dwell time to bond fabric-contact face 316 to the surface region. Where attachment interface 108 includes hook-and-loop components 306a and 306b, installation instructions 1002 may direct a user to apply second hook-and-loop component 306b to a surface region of apparel substrate 104 (for example, by applying an adhesive backing of second hook-and-loop component 306b to the surface region, or by stitching second hook-and-loop component 306b to the surface region) and to engage first hook-and-loop component 306a of display pocket 102 with second hook-and-loop component 306b.

In certain embodiments, the kit may further include one or more additional elements. Additional elements may include a garment-preparation wipe (e.g., an isopropyl-alcohol-impregnated cloth or a lint roller), an application tool (e.g., a roller or a squeegee for pressing adhesive layer 304 against apparel substrate 104), an alignment template (e.g., a paper or polymer template defining the intended position of display pocket 102 on apparel substrate 104), a set of replacement identification inserts 106, a set of replacement attachment interfaces 108 (e.g., additional adhesive strips, additional hook-and-loop components, or additional snap components), or a storage pouch 1004 operable to hold display pocket 102 and identification insert 106 between uses.

In certain embodiments, the kit may be configured to support installation of multiple display pockets 102 on a single apparel substrate 104 or on a plurality of apparel substrates 104. For example, the kit may include a plurality of display pockets 102 and a corresponding plurality of attachment interfaces 108 for installation on different regions of a single apparel substrate 104 (e.g., a chest region and a back region) or for installation on different apparel substrates 104 (e.g., multiple garments worn across multiple events). In certain embodiments, the kit may be configured as a studio-level or team-level kit operable to equip a roster of participants with individually labeled identification inserts 106 and a shared pool of display pockets 102.

In certain embodiments, the kit may be packaged in a retail-ready format including a carton, a blister pack, a bag, or a box, with installation instructions 1002 printed on an interior face of the packaging or on an enclosed instruction sheet. The kit may be distributed through retail channels, direct-to-consumer channels, event-registration packages, studio distribution channels, or team distribution channels.

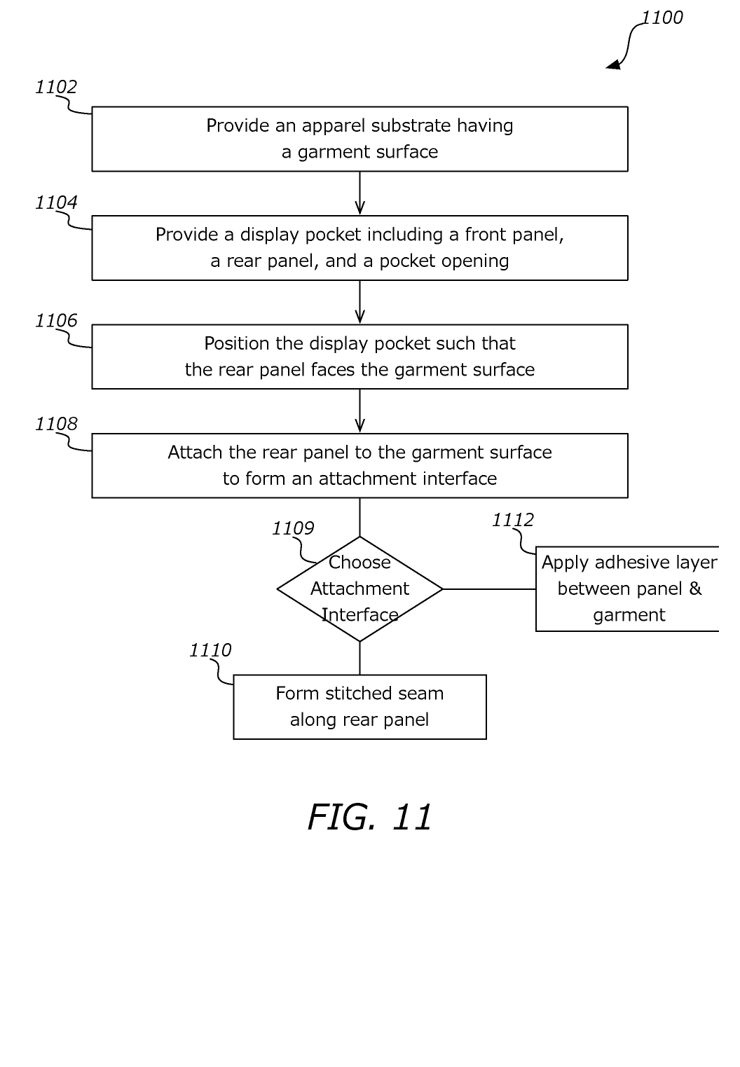

### FIG. 11 — Method of Manufacture

FIG. 11 illustrates an example method 1100 for manufacturing an identification display system, in accordance with various embodiments. As shown in FIG. 11, method 1100 includes step 1102, step 1104, step 1106, decision 1109, and step 1108, performed in sequence or in a modified sequence as described below. Step 1108 may include one or more sub-operations selected based on the attachment style chosen at decision 1109, including, as non-limiting examples, step 1110 (forming a stitched seam along rear panel 114) and step 1112 (applying an adhesive layer between rear panel 114 and the garment surface of apparel substrate 104). Other sub-operations of step 1108 corresponding to other attachment styles are also contemplated, including those described below and those described in connection with FIGS. 3C-3G. Decision 1109 selects an attachment style for display pocket 102 from among the attachment mechanisms described in connection with FIGS. 3A-3G, and the attachment style selected at decision 1109 determines the sub-operations performed at step 1108.

At step 1102, an apparel substrate including a garment surface is provided. Apparel substrate 104 may be provided as a finished garment (e.g., a shirt, a jersey, a leotard, or a vest), as a panel of garment material prior to garment assembly, as a cut-and-sewn garment preform, or as a fabric roll for continuous-feed processing. The garment surface of apparel substrate 104 is the surface region of apparel substrate 104 on which display pocket 102 is to be applied, and may include an exterior surface of apparel substrate 104, an interior surface of apparel substrate 104 in embodiments in which display pocket 102 is applied to an interior of apparel substrate 104, or an interlining surface in multi-layer garment constructions.

More specifically, apparel substrate 104 provided at step 1102 may include one or more garment types described in connection with FIG. 1A. The garment surface may be prepared for attachment of display pocket 102 by one or more preparation actions, including cleaning the garment surface to remove dust, lint, or manufacturing residue; marking the garment surface with an alignment mark (e.g., a chalk mark, a pen mark, or a printed template) indicating the intended position of display pocket 102; or applying a primer or surface activation treatment (e.g., a corona treatment or a plasma treatment) operable to improve adhesion of an adhesive layer 304 at step 1108.

At step 1104, a display pocket is provided. Display pocket 102 provided at step 1104 includes front panel 112, rear panel 114 joined to front panel 112 along bottom edge 122 of display pocket 102 and along two side edges 124 of display pocket 102, and pocket opening 116 between front panel 112 and rear panel 114, pocket opening 116 extending along upper edge 120 of display pocket 102 opposing bottom edge 122.

More specifically, display pocket 102 may be provided as a completed subassembly (e.g., with front panel 112 and rear panel 114 pre-joined along bottom edge 122 and side edges 124, and optionally with frame or border layer 110 and an attachment interface 108 pre-installed on rear panel 114) or as a set of components for assembly during manufacture. Display pocket 102 may be sourced from a supplier, fabricated in-line during garment manufacture, or pre-positioned on a manufacturing fixture for integration with apparel substrate 104 at step 1106.

At step 1106, display pocket 102 is positioned against apparel substrate 104 with rear panel 114 facing the garment surface of apparel substrate 104. Positioning at step 1106 aligns rear panel 114 with the region of the garment surface intended to receive display pocket 102, such that attachment at step 1108 forms attachment interface 108 between rear panel 114 and the garment surface. Positioning may be performed manually by a manufacturing operator, semi-automatically using an alignment fixture or template, or fully automatically using a pick-and-place machine equipped with machine vision operable to identify the target region on apparel substrate 104.

More specifically, positioning at step 1106 may include orienting display pocket 102 so that upper edge 120 faces a head or neck region of apparel substrate 104 (e.g., such that identification insert 106 can be inserted into pocket opening 116 from above the wearer's line of sight), or may include orienting display pocket 102 so that upper edge 120 faces a waist or hip region of apparel substrate 104 (e.g., in embodiments in which identification insert 106 is to be inserted from below). Positioning may include rotational alignment (e.g., ensuring that display pocket 102 is oriented portrait or landscape as intended), translational alignment (e.g., ensuring that display pocket 102 is centered laterally on apparel substrate 104 or offset to a specific region), and distance-to-edge alignment (e.g., ensuring that display pocket 102 is positioned at a predetermined distance from a seam, neckline, or hem of apparel substrate 104).

At decision 1109, an attachment style is selected for display pocket 102. Decision 1109 selects among a plurality of attachment mechanisms including a stitched seam 302 (as described in connection with FIG. 3A), an adhesive layer 304 (as described in connection with FIG. 3B), a hook-and-loop component 306aand 306b(as described in connection with FIG. 3C), a magnetic element 308a and 308b (as described in connection with FIG. 3D), a zipper 310 (as described in connection with FIG. 3E), a snap component 312 (as described in connection with FIG. 3F), or a thermally-bonded seam 314 (as described in connection with FIG. 3G). The selection made at decision 1109 routes method 1100 to the sub-operations performed at step 1108.

More specifically, decision 1109 may be performed as an explicit operator-selection step within a manufacturing process (e.g., by an operator selecting an attachment style from a manufacturing instruction template or a work-order configuration), as a configuration setting of an automated manufacturing line (e.g., by a controller routing apparel substrate 104 to a specific attachment station based on a product-configuration identifier read from a job ticket or a machine-readable label), or as a branch point in a user-facing installation workflow (e.g., where method 1100 is executed by an end user applying display pocket 102 to apparel substrate 104 using a user-selectable attachment mechanism described in installation instructions distributed with a kit). The attachment style selected at decision 1109 may be recorded in a manufacturing log, a configuration record, or a product-tracking database to support traceability, warranty attribution, or rework operations across a production run.

In certain embodiments, decision 1109 may select two or more attachment mechanisms operable to act in combination. For example, decision 1109 may select stitched seam 302 for a perimeter of rear panel 114 and adhesive layer 304 for a central region of rear panel 114, such that step 1108 performs both stitching and adhesive bonding to form a combined attachment interface 108. In certain embodiments, decision 1109 may be conditioned on one or more properties of apparel substrate 104 (e.g., fabric composition, fabric thickness, launderability requirements, or intended use duration), such that the selected attachment style matches the physical and operational characteristics of apparel substrate 104.

At step 1108, rear panel 114 of display pocket 102 is attached to the garment surface of apparel substrate 104 to form attachment interface 108 between rear panel 114 and the garment surface. Attaching at step 1108 is performed using the attachment style selected at decision 1109 and includes the sub-operations associated with that style, as described below.

At step 1110, stitched seam 302 is formed along a perimeter of rear panel 114 by passing thread 322 through rear panel 114 and the garment surface of apparel substrate 104. Step 1110 is a non-limiting example of a sub-operation performed at step 1108 in embodiments in which decision 1109 selects a stitched-seam attachment style, and is one of a plurality of sub-operations of step 1108 that may be selected at decision 1109 as described below.

More specifically, step 1110 may be performed using an industrial sewing machine, a programmable pattern stitching machine, or a manual or automated embroidery machine. Step 1110 may include forming a single-perimeter stitch pattern, a double-perimeter stitch pattern, a cross-stitched corner pattern, or another reinforcement pattern selected based on anticipated retention requirements and garment construction.

At step 1112, adhesive layer 304 is applied between rear panel 114 and the garment surface of apparel substrate 104. Step 1112 is a further non-limiting example of a sub-operation performed at step 1108, in embodiments in which decision 1109 selects an adhesive attachment style.

More specifically, step 1112 may include positioning adhesive layer 304 between rear panel 114 and the garment surface (e.g., by removing release liner 320 from fabric-contact face 316 of adhesive layer 304 pre-applied to rear panel 114, or by dispensing adhesive layer 304 onto the garment surface prior to positioning rear panel 114), applying an application force between rear panel 114 and the garment surface to bond fabric-contact face 316 of adhesive layer 304 to the garment surface and pocket-contact face 318 of adhesive layer 304 to rear panel 114, and maintaining the application force for a bonding dwell time sufficient to form a substantially permanent bond between adhesive layer 304 and both rear panel 114 and the garment surface. In such embodiments, adhesive layer 304 is formulated to retain rear panel 114 on the garment surface under a tensile load applied to apparel substrate 104 and to separate from the garment surface without visible adhesive residue on the garment surface upon removal of display pocket 102, as further described in connection with FIG. 3B and the adhesive-layer functional-performance subsection.

In embodiments in which attaching at step 1108 includes forming thermally-bonded seam 314, step 1108 may include positioning fusible material between rear panel 114 and the garment surface, applying heat and pressure to fuse fusible material with rear panel 114 and with the garment surface using a heat press, an iron, a continuous-press lamination station, an ultrasonic bonding station, or a radio-frequency welding station, and cooling the bonded region to solidify thermally-bonded seam 314. In embodiments in which attaching at step 1108 includes releasable attachment mechanisms (hook-and-loop, magnetic, snap, or zipper), step 1108 may include coupling the pocket-side component of the attachment mechanism to rear panel 114 and coupling the garment-side component of the attachment mechanism to the garment surface, such that the pocket-side and garment-side components are engageable to couple display pocket 102 to apparel substrate 104 during subsequent use.

Method 1100 may further include one or more optional steps, performed before, after, or during the steps described above. Optional steps may include providing identification insert 106 and inserting identification insert 106 through pocket opening 116 into display pocket 102 following attachment of display pocket 102 to apparel substrate 104; applying frame or border layer 110 around a perimeter of display pocket 102 before or during step 1108; installing flap 402 along upper edge 120 of display pocket 102; inspecting attachment interface 108 for defects; and packaging the completed identification display system for distribution as a kit.

Method 1100 may be performed in alternative sequences in certain embodiments. For example, step 1104 (providing display pocket 102) and step 1102 (providing apparel substrate 104) may be performed substantially concurrently, or in reverse order, in embodiments in which both components are sourced separately. Step 1106 (positioning) and step 1108 (attaching) may be performed substantially continuously in continuous-feed manufacturing processes, in which apparel substrate 104 is translated past a positioning and attachment station that performs both steps on sequential garments.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

Any of the above mentioned systems, units, modules, engines, controllers, components, process steps or the like may be and/or comprise hardware and/or software as described herein. For example, the systems, engines, and subcomponents described herein may be and/or comprise computing hardware and/or software as described herein in association with FIGS. 12-15. Furthermore, any of the above mentioned systems, units, modules, engines, controllers, components, interfaces or the like may use and/or comprise an application programming interface (API) for communicating with other systems units, modules, engines, controllers, components, interfaces or the like for obtaining and/or providing data or information.

Referring now to FIG. 12, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random-access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 12 illustrates one specific architecture for a computing device 10 for implementing one or more of the embodiments described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, single processor 13 handles communications as well as routing computations, while in other embodiments a separate dedicated communications processor may be provided. In various embodiments, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

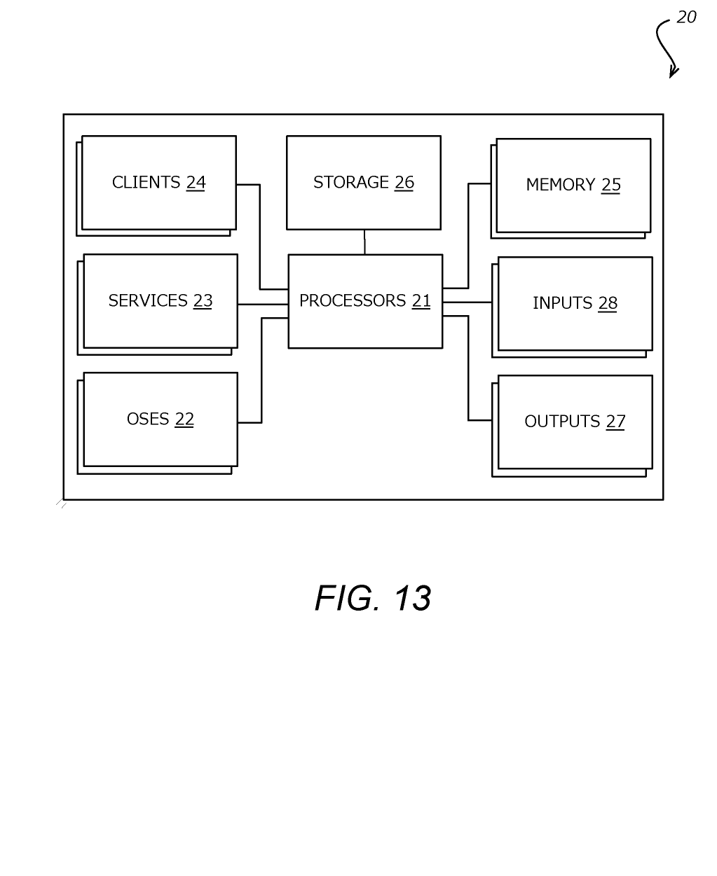

In some embodiments, systems may be implemented on a standalone computing system. Referring now to FIG. 13, there is shown a block diagram depicting a typical exemplary architecture of one or more embodiments or components thereof on a standalone computing system. Computing device 20 includes processors 21 that may run software that carry out one or more functions or applications of embodiments, such as for example a client application. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 12). Examples of storage devices 26 include flash memory, magnetic hard drive, CD-ROM, and/or the like.

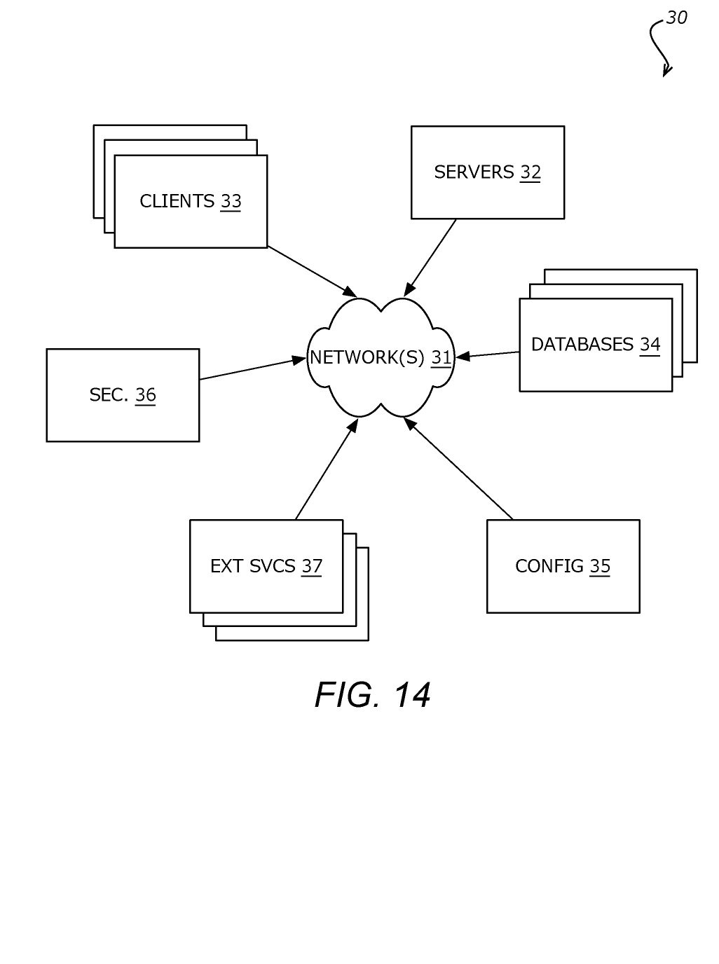

In some embodiments, systems may be implemented on a distributed computing network, such as one having any number of clients and/or servers. Referring now to FIG. 14, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 13. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in one aspect where client applications are implemented on a smartphone or other electronic device, client applications may obtain information stored in a server system 32 in the cloud or on an external service 37 deployed on one or more of a particular enterprise’s or user’s premises.

In some embodiments, clients 33 or servers 32 (or both) may make use of one or more specialized services or appliances that may be deployed locally or remotely across one or more networks 31. For example, one or more databases 34 may be used or referred to by one or more embodiments. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some embodiments may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments without limitation, unless a specific security 36 or configuration system 35 or approach is specifically required by the description of any specific aspect.

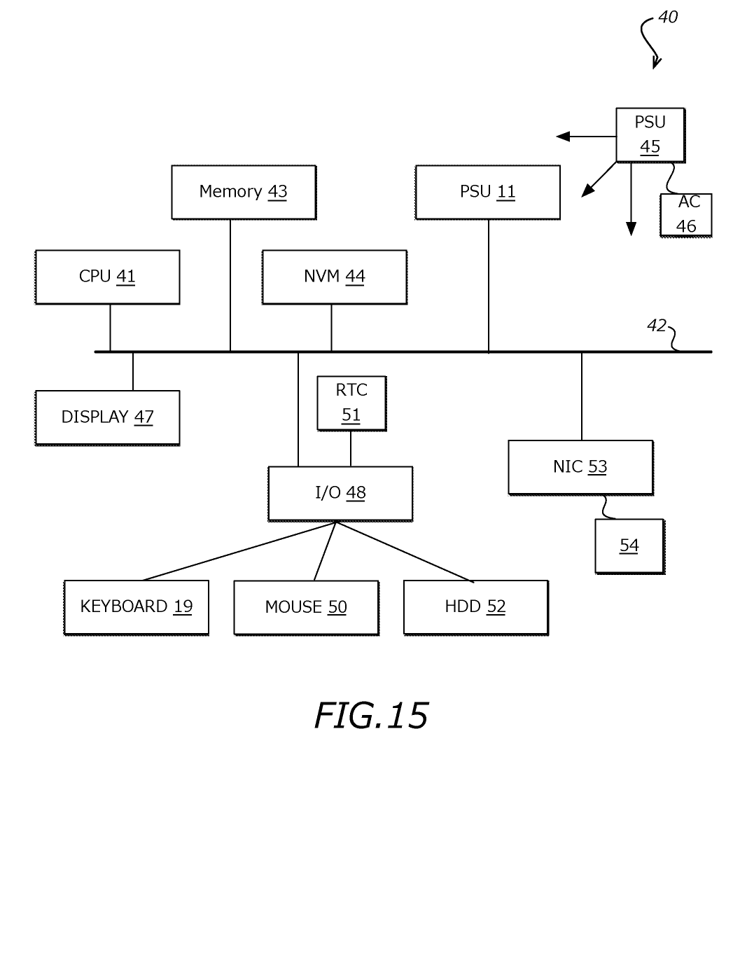

FIG. 15 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of various embodiments may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various embodiments described above. Accordingly, the present invention is defined by the claims and their equivalents.

### Additional Elements and Use Configurations

### User-Installable Configuration

In certain embodiments, display pocket 102 is distributed as a user-installable product. Display pocket 102 may be provided with attachment interface 108 pre-applied to rear panel 114 (e.g., with adhesive layer 304 and release liner 320 pre-applied, or with first hook-and-loop component 306apre-applied). A user is operable to apply display pocket 102 to an existing apparel substrate 104 without professional installation, garment alteration, or specialized equipment. User-installable embodiments may be distributed through retail channels, direct-to-consumer channels, event-registration packages, or studio distribution channels. In certain embodiments, user-installable embodiments may include a kit as described in connection with FIG. 10.

### Integrated Manufacturing Configuration

In certain embodiments, display pocket 102 is integrated into apparel substrate 104 during manufacture of apparel substrate 104. Attachment interface 108 may be applied using industrial stitching equipment, ultrasonic welding equipment, heat-press bonding equipment, or automated adhesive-placement equipment, and display pocket 102 may be aligned with apparel substrate 104 using a template fixture, a machine-vision alignment system, or a combination thereof. In factory-integrated embodiments, method 1100 (FIG. 11) may be executed as part of the apparel-substrate manufacturing process, reducing post-manufacture handling and ensuring repeatable placement of display pocket 102 across a production run.

### Branding and Customization

Display pocket 102 may include a designated region for branding, team insignias, event identification, or studio identification. In certain embodiments, frame or border layer 110 may include embossed or printed logos, stitched labels, or replaceable branding strips on an exterior-facing face of frame or border layer 110. In certain embodiments, a branding element may be provided as a secondary insert placed between front panel 112 and rear panel 114 at a position adjacent to or behind identification insert 106, such that both the branding element and identification insert 106 are visible through viewing region 118. Branding elements may be integrated during manufacture, added to kit distributions as separate components, or applied by end users as removable overlays.

### Identification Insert Variants

Identification insert 106 may include a wide range of identification content, as further described in connection with FIG. 1A. Identification insert 106 may carry alphanumeric identifiers, names, barcodes, QR codes, data matrix codes, aztec codes, NFC tags, RFID tags, or a combination thereof. Identification insert 106 may be printed on paper, cardstock, synthetic films, laminated substrates, or flexible polymers. In certain embodiments, identification insert 106 may be encoded or color-coded based on event role, security clearance, team assignment, or similar categorical attributes. Use cases for identification insert 106 include dance competitions, athletic events, team uniforms, performance costumes, backstage crew coordination, educational programs, event-based access control, and staff identification.

### Placement Variants Across Garment Zones

Display pocket 102 may be coupled to apparel substrate 104 at any of multiple positions on apparel substrate 104, including an upper-chest region, a lower-torso region, a hip region, a shoulder region, a sleeve region, a back region, a thigh region, or an accessory region (e.g., a sash, an armband, a headband, or a belt). Placement may be selected based on visibility requirements, garment cut, and the activity for which apparel substrate 104 is used. In certain embodiments, two or more display pockets 102 may be coupled to a single apparel substrate 104, each display pocket 102 operable to carry a distinct identification insert 106. The attachment interfaces described in connection with FIGS. 3A-3G are compatible with any of the foregoing placement regions.

### Multiple-Pocket Configurations

In certain embodiments, identification display system 100 may include a plurality of display pockets 102 coupled to a single apparel substrate 104. Each display pocket 102 may retain a separate identification insert 106, supporting use cases in which multiple identifiers are to be displayed simultaneously (e.g., a participant name and a team affiliation, a role designation and a numeric identifier, or a primary identifier and a sponsor branding element). Display pockets 102 may be arranged side-by-side, stacked vertically, in a symmetrical pattern across apparel substrate 104, or in an asymmetrical pattern, depending on garment design and visibility requirements. Each display pocket 102 may include a separate attachment interface 108 of the same type or of a different type relative to the other display pockets 102.

### Dissolvable and Releasable Adhesive Configurations

In certain embodiments, adhesive layer 304 may include a dissolvable or thermally-releasable adhesive chemistry operable to release display pocket 102 from apparel substrate 104 upon exposure to a triggering condition. The triggering condition may include immersion in water during laundering, exposure to heat during a laundering cycle or drying cycle, or application of a release solvent. Dissolvable adhesive chemistries may include water-soluble polyvinyl alcohol films, thermally-releasable hot-melt films with a release temperature above ordinary wear temperatures, or enzymatically degradable adhesives. Such configurations support use cases in which display pocket 102 is intended for single-event use with subsequent clean removal during routine garment care.

### Development and Material Variations

Material selection for front panel 112, rear panel 114, frame or border layer 110, and attachment interface 108 may be varied across embodiments. Variations may be selected to balance optical clarity of viewing region 118 against durability of front panel 112 against impact, folding, and abrasion; to balance dimensional stability of display pocket 102 against conformability to curved garment surfaces; to balance retention strength of attachment interface 108 against removability and garment impact; and to balance weight and bulk of display pocket 102 against appearance and wearer comfort. Example material combinations are described above in connection with each component. Additional combinations of the foregoing materials are within the scope of the disclosure.

### Expansion Kits and Modular Configurations

In certain embodiments, identification display system 100 may be distributed as an expansion kit operable to supplement an existing identification display system 100. An expansion kit may include one or more additional display pockets 102 sized to couple to an existing garment-side attachment component (e.g., a second hook-and-loop component 306bor a second magnetic element 308balready present on apparel substrate 104), one or more additional identification inserts 106, one or more replacement attachment interfaces 108, or a combination thereof. Expansion kits support use cases in which a user maintains a fixed garment-side attachment architecture across multiple apparel substrates 104 and selects among a library of display pockets 102 or identification inserts 106 as needed for a given event.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for identification display through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. An identification display apparatus comprising:
a display pocket including a front panel, a rear panel joined to the front panel along a bottom edge of the display pocket and along two side edges of the display pocket, and a pocket opening between the front panel and the rear panel,
the pocket opening extending along an upper edge of the display pocket opposing the bottom edge, the pocket opening sized to receive an identification insert through the pocket opening,
the front panel including a viewing region dimensioned to render the identification insert visible through the front panel after the identification insert is received between the front panel and the rear panel; and
an attachment interface coupled to the rear panel, the attachment interface arranged to couple the display pocket to an apparel substrate.

2. The identification display apparatus of claim 1, further comprising a flap coupled along the upper edge of the display pocket at a fixed edge of the flap, the flap foldable about the fixed edge between a first position exposing the pocket opening and a second position covering the pocket opening.

3. The identification display apparatus of claim 1, wherein the front panel and the rear panel are biased toward each other along the pocket opening, the bias arranged to form a pressure fit against the identification insert received between the front panel and the rear panel.

4. The identification display apparatus of claim 1, wherein an interior face of the front panel, an interior face of the rear panel, or both include a textured friction surface, the textured friction surface arranged to engage the identification insert received between the front panel and the rear panel through friction to retain the identification insert.

5. The identification display apparatus of claim 1, wherein the attachment interface includes a hook-and-loop component coupled to the rear panel, the hook-and-loop component engageable with a mating hook-and-loop component for coupling the display pocket to the apparel substrate.

6. The identification display apparatus of claim 1, wherein the attachment interface includes a magnetic element coupled to the rear panel, the magnetic element arranged to magnetically couple the display pocket to a mating magnetic element or a ferromagnetic region associated with the apparel substrate.

7. The identification display apparatus of claim 1, wherein the attachment interface includes a snap component coupled to the rear panel, the snap component including a male connector element or a female connector element, the snap component arranged to mechanically engage a mating connector element on the apparel substrate.

8. The identification display apparatus of claim 1, further comprising the identification insert received through the pocket opening and retained between the front panel and the rear panel, and a set of installation instructions, the installation instructions describing a process for coupling the display pocket to an apparel substrate through the attachment interface.

9. The identification display apparatus of claim 1, wherein the display pocket further comprises a flexible display medium operable to render alphanumeric identification data, the flexible display medium electrically coupled to a controller.

10. An identification display system comprising:
a display pocket including a front panel, a rear panel joined to the front panel along a bottom edge of the display pocket and along two side edges of the display pocket, and a pocket opening between the front panel and the rear panel, the pocket opening extending along an upper edge of the display pocket opposing the bottom edge, the front panel including a viewing region;
an attachment interface coupled to the rear panel, the attachment interface operable to couple the display pocket to an apparel substrate; and
an identification insert received through the pocket opening and retained between the front panel and the rear panel, the identification insert visible through the viewing region of the front panel.

11. The identification display system of claim 10, further comprising an apparel substrate having a garment surface, wherein the attachment interface includes a stitched seam extending along a perimeter of the rear panel, the stitched seam including a thread passing through the rear panel and the garment surface along the perimeter.

12. The identification display system of claim 10, further comprising an apparel substrate having a garment surface, wherein the attachment interface includes an adhesive layer between the rear panel and the garment surface, the adhesive layer including a fabric-contact face bonded to the garment surface and a pocket-contact face bonded to the rear panel, wherein the adhesive layer retains the display pocket on the apparel substrate under a tensile load applied to the apparel substrate and separates from the garment surface without visible adhesive residue on the garment surface.

13. The identification display system of claim 10, further comprising an apparel substrate having a garment surface, wherein the attachment interface includes a first hook-and-loop component coupled to the rear panel and a second hook-and-loop component coupled to the garment surface, the first hook-and-loop component and the second hook-and-loop component releasably engageable to couple the display pocket to the apparel substrate.

14. The identification display system of claim 10, further comprising an apparel substrate having a garment surface, wherein the attachment interface includes a first magnetic element coupled to the rear panel and a second magnetic element coupled to the garment surface, the first magnetic element and the second magnetic element arranged to magnetically couple the display pocket to the apparel substrate.

15. The identification display system of claim 10, further comprising an apparel substrate having a garment surface, wherein the attachment interface includes a thermally-bonded seam between the rear panel and the garment surface, the thermally-bonded seam formed by thermal fusion of a fusible material between the rear panel and the garment surface.

16. The identification display system of claim 10, wherein the identification insert includes a perforated tear line separable under a tearing force to detach a portion of the identification insert from a remainder of the identification insert, the remainder retained between the front panel and the rear panel after detachment of the portion.

17. The identification display system of claim 10, wherein the identification insert includes a re-writable surface, the re-writable surface including a first region supporting a first identification marking and a second region supporting a second identification marking, the first identification marking and the second identification marking replaceable by rewriting the re-writable surface.

18. A method for manufacturing an identification display system, the method comprising:
providing an apparel substrate including a garment surface;
providing a display pocket including a front panel, a rear panel joined to the front panel along a bottom edge of the display pocket and along two side edges of the display pocket, and a pocket opening between the front panel and the rear panel, the pocket opening extending along an upper edge of the display pocket opposing the bottom edge;
positioning the display pocket against the apparel substrate with the rear panel facing the garment surface; and
attaching the rear panel of the display pocket to the garment surface of the apparel substrate to form an attachment interface between the rear panel and the garment surface.

19. The method of claim 18, wherein attaching the rear panel to the garment surface comprises passing a thread through the rear panel and the garment surface along a perimeter of the rear panel to form a stitched seam between the rear panel and the garment surface.

20. The method of claim 18, wherein attaching the rear panel to the garment surface comprises applying an adhesive layer between the rear panel and the garment surface, the adhesive layer bonded to the garment surface and to the rear panel, the adhesive layer retaining the rear panel on the garment surface under a tensile load applied to the apparel substrate and separable from the garment surface without visible adhesive residue on the garment surface.
